(19) United States
(12) Patent Application Publication
(10) Pub. No.: US 2014/0356051 A1
(43) Pub. Date: Dec. 4, 2014

(54) Mitered Joint Compression Fastener

(71) Applicant: Daniel Korb, Baden (CH)

(72) Inventor: Daniel Korb, Baden (CH)

(21) Appl. No.: 13/906,975

(22) Filed: May 31, 2013

(51) Int. Cl. F16B 12/40; F16B 12/44

(52) U.S. Cl. CPC F16B 12/40; F16B 12/44
USPC 403/205

(57) ABSTRACT

Disclosed is a four piece symmetrical compression fastener for a mitered joint. The fastener includes two L-brackets, each L-bracket having two flat plates intersecting each other at angles in two dimensions, the intersecting edges of the flat plates forming two right angles. The L-brackets are spaced apart from each other by both a large L-brace and a small L-brace, each brace interconnecting with each flat plate of each L-bracket. Upon the fastener being inserted into two mitered joining pieces, the flat plates of the L-brackets are compressed into curved plates that press against the interior of the joining piece and secure the fastener within the pieces. The two mitered joining pieces cooperate to fully enclose the compression fastener.

### CROSS REFERENCE TO COPENDING APPLICATIONS

This application claims priority to German Patent applications DE 20 2012 104 021.2 entitled Einrichtungsgegenstand and filed Oct. 19, 2012, and DE 20 2013 100 898.2 entitled Konstruktionsein heit, insbesondere far Mabel filed Mar. 1, 2013, the contents of which are all herein incorporated by reference.

### FIELD OF THE INVENTION

The invention relates to fasteners for miter joints and more specifically to compression fasteners without external tightening devices.

### BACKGROUND OF THE INVENTION

Hidden compression fasteners for miter joints, such as the one disclosed in U.S. Patent Application Publication 2011/0286792 by Henriott typically include externally accessible cams or screws used for engaging the fasteners. The access points for these fasteners are often placed on sides of the joined pieces that are rarely seen. The fasteners are also often recessed into joined pieces to further reduce their visibility. However, there are numerous instances where all sides of the joined pieces are visible and having externally accessible fasteners is not optimal. Additionally, holes must often be drilled into the joined pieces so that the externally accessible fasteners may be later added. These holes increase the cost of producing the joined pieces and may weaken the structural integrity of the pieces.

### SUMMARY OF THE INVENTION

Disclosed is a four piece symmetrical compression fastener for a miter joint. The fastener includes two L-brackets, each L-bracket having two flat plates intersecting each other at angles in two dimensions, the intersecting edges of the flat plates forming two right angles. The L-brackets are spaced apart from each other by both a large L-brace and a small L-brace, each brace interconnecting with each flat plate of each L-bracket. Upon the fastener being inserted into joining pieces, the flat plates of the L-brackets are compressed into curved plates that press against the interiors of the joining pieces and secure the fastener within the pieces. The two mitered joining pieces cooperate to fully enclose the compression fastener.

### BRIEF DESCRIPTION OF THE DRAWINGS

FIG. 1 is a front view of an uncompressed four piece fastener.

FIG. 2 is a top view of an uncompressed four piece fastener.

FIG. 3 is a side view of an uncompressed four piece fastener.

FIG. 4 is a perspective exploded view of an uncompressed four piece fastener.

FIG. 5 is a front exploded view of an uncompressed four piece fastener.

FIG. 6 is a side view of a large L-brace and a small L-brace.

FIG. 7 is a perspective view of a large L-brace and a small L-brace.

FIG. 8 is a perspective view of a table leg or joining piece.

FIG. 9A is a top view of a table leg or joining piece.

FIG. 9B is a top view of a joining piece with an uncompressed fastener.

FIG. 9C is a top view of a joining piece with a compressed fastener.

FIG. 10 is a side view of a joining piece highlighting the mitered end.

FIG. 11 is a perspective view of a compressed four piece fastener secured in a table leg.

FIG. 12 is a perspective view of a compressed four piece fastener.

FIG. 13 is a front view of a compressed four piece fastener.

FIG. 14 is a top view of a compressed four piece fastener.

FIG. 15 is a side view of a compressed four piece fastener.

FIG. 16 is a front exploded view of a compressed four piece fastener.

FIG. 17 is a top perspective view of two joining pieces secured together by a compressed four piece fastener.

FIG. 18 is a side perspective view of two joining pieces secured together by a compressed four piece fastener.

FIG. 19 is a perspective view of a joining piece or table leg with a rectangular exterior.

FIG. 20 is a perspective view of a four piece fastener and a joining piece secured together at greater than a 90 degree angle.

FIG. 21 is a side view of two joining pieces secured together by a compressed four piece fastener at an obtuse angle.

FIG. 22 is a side view of an uncompressed four piece fastener.

FIG. 23A shows a coupling unit for securing cross braces to joining pieces.

FIG. 23B shows an exploded view of a coupling unit for securing cross braces to joining pieces.

FIG. 24 shows several different views of a coupling unit in an assembled state.

FIG. 25A shows several view of a table leg with an extendable strut.

FIG. 25B shows a table leg and extendable strut at various predetermined height settings.

FIG. 25C shows views of a disassembled adjustable height table leg.

FIGS. 25D and 25E show a detailed view of the adjustable height table leg mechanism.

FIGS. 25F and 25G show isolated views of the locking mechanism in the adjustable height table leg mechanism.

FIG. 26A shows a front, lower, and side view of a table structure.

FIG. 26B shows a lower perspective view of an assembled table.

FIG. 27 shows an assembled table system with several construction units.

FIG. 28 shows an assembled table system with several construction units from below.

FIG. 29 shows a furniture system with a combination of table and chest pieces supported by construction units.

FIGS. 30A and 30B are close up views of different sections of a table system.

FIG. 31A is a perspective view of a cross leg secured to a cross brace.

FIG. 31B is a side view of a cross leg secured to a cross brace.

FIG. 31C is a perspective view of a disassembled cross leg and brace.

FIG. 31D is a side view of a cross section of a disassembled cross leg and brace.

FIG. 31E is a side view of a cross section of a disassembled cross leg and brace.

FIG. 32A is a perspective view of an unassembled joint with a cross leg securable to multiple cross braces.

FIG. 32B is a perspective view of an assembled joint with a cross leg secured to multiple cross braces.

FIG. 32C is a front view of an assembled joint with a cross leg and multiple cross braces.

FIG. 32D is a side view of an assembled joint with a cross leg and multiple cross braces.

FIG. 32E is a side view of an unassembled joint with a cross leg secured to multiple cross braces.

FIG. 32F is a detailed side view of an assembled joint with a cross leg secured to multiple cross braces.

FIG. 33A is a view of an assembled table support unit.

FIG. 33B is a view of a disassembled table support unit.

FIG. 33C is a side view of an assembled table support unit.

FIG. 33D is a side view of a disassembled table support unit.

FIG. 33E shows several views of a table support unit.

FIG. 33F shows a detailed view of the bracket of a table support unit.

FIG. 34A shows a perspective view of an assembled table support unit having two lateral arms.

FIG. 34B shows a perspective view of a disassembled table support unit having two lateral arms.

FIG. 34C shows a side view of an assembled table support unit having two lateral arms.

FIG. 34D shows a side view of a disassembled table support unit having two lateral arms.

FIG. 34E shows various views the assembled table support unit.

FIG. 34F shows a detailed view of the U-shaped piece of the table support unit.

FIG. 35 is a detailed view of an insert piece for a table support unit.

### DETAILED DESCRIPTION

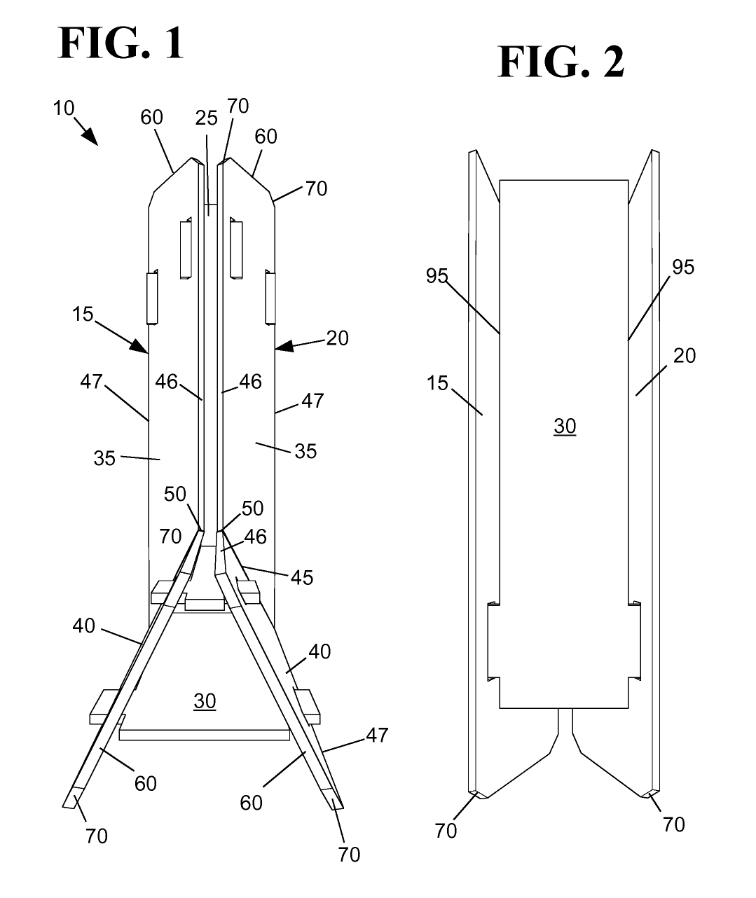

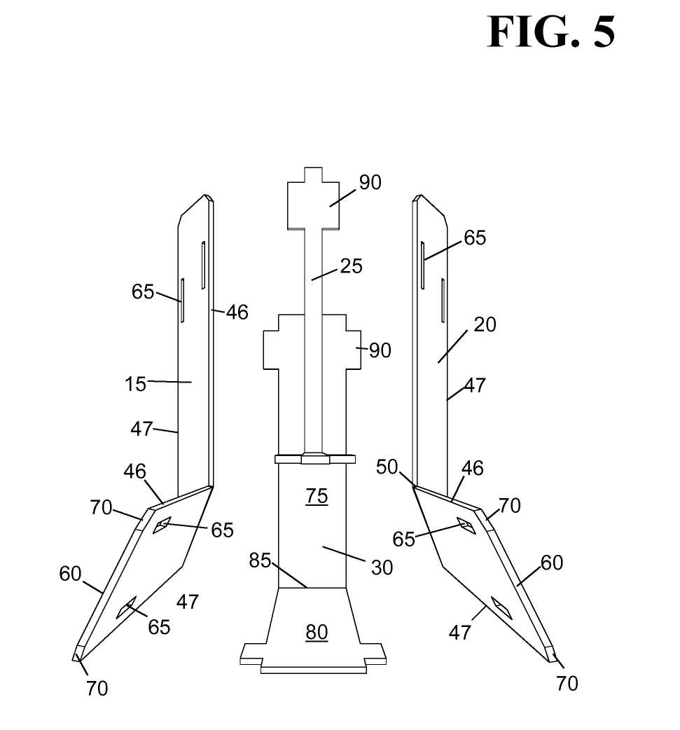

FIGS. 1 through 5 illustrate an uncompressed four piece compression fastener 10 having a first L-bracket 15, a second L-bracket 20, a small L-brace 25 and a large L-brace 30. Each L-bracket includes a first flat plate 35 and a second flat plate 40 secured together at a junction 45 angled in both a first dimension and a second dimension relative to the plane of the first flat plate 35. The connecting edges of the first flat plate 35 and the second flat plate 40 intersect at an interior right angle 50 and an exterior right angle 55. The junction 45 of the two flat plates (35, 40) runs at approximately a 45 degree angle to the inserted ends 60 of the flat plates that are adapted to be inserted into table legs or other objects that are joined together.

Each of the two flat plates (35, 40) includes a short edge 46 and a long edge 47. The short edges 46 of each L-bracket intersect each other at the interior right angle 50 and are perpendicular to each other. The long edges 47 of each L-bracket also intersect each other at the exterior right angle 55. The short edges 46 and long edges 47 of the first flat plates 35 run parallel to each other while the short edges 46 and long edges 47 of the second flat plates 40 also run parallel to each other. Two edges or lines that are parallel to each other are always coplanar in a geometric plane. The short and long edges (46, 47) of the first and second plates (35, 40) are perpendicular to each other and are non-coplanar. The junction 45 of a single bracket is coplanar with both the combination of the short and long edges of the first plate and the combination of the short and long edges of the second plate. The combination of the short and long edges of the first plate is not coplanar with the combination of short and long edges of the second plate. The junction 45 fully extends between the short edges 46 and the long edges 47.

For each L-bracket, the faces of the two inserted ends 60 are located in geometric planes that are perpendicular to each other. The flat plates have flat surfaces that extend from the junctions 45 to the inserted ends 60 when the plates are not compressed within a joining piece. The flat surfaces are bendable by compression and extend from the short edges 46 to the long edges 47 of the flat plates. The flat surfaces of the two plates of a bracket meet at the junction.

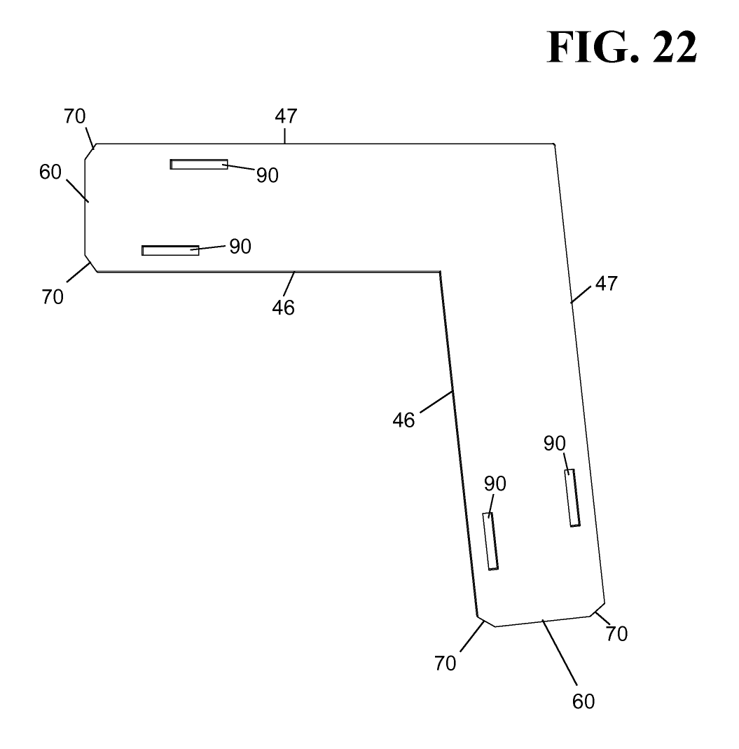

The L-brackets may be constructed from two flat plates that have been welded or otherwise secured together at the junction, or the L-brackets may be created by folding flat sheets of metal such as the one shown in FIG. 22. By the L-brackets having two flat plates that are angled from each other in two dimensions, an extremely rigid and robust connection is formed that resists bending forces in three dimensions.

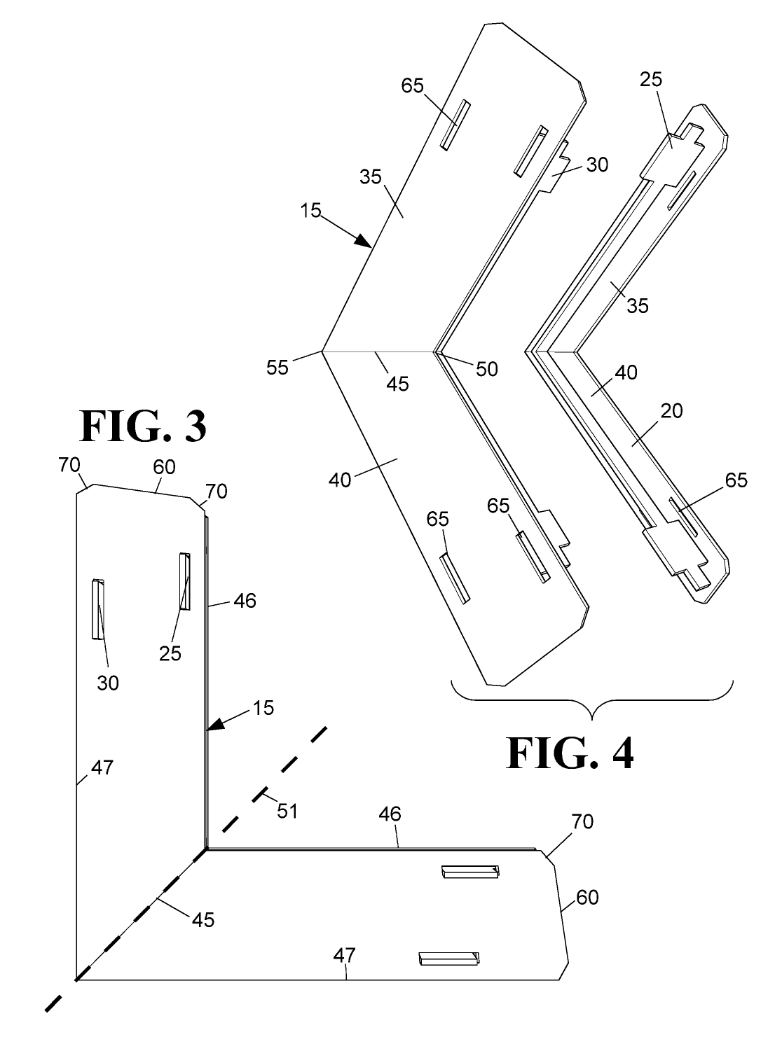

The L-brackets also include four slots 65 that are adapted to receive portions of the large and small L-braces. Each flat plate of the L-bracket has at least one slot for the large L-brace and one slot for the small L-brace, however more may be added based on the design and usage of the fastener. For example, additional slots may be used on a flat plate that is particularly long, or if the flat plate is constructed of a particularly flexible material. In the illustrated example, the slots 65 that are configured to receive the portions of the small L-brace 25 are closer to the inserted ends 60 than the slots configured to receive portions of the large L-brace 30. In alternative examples, the slots may be at equal distances from the inserted ends 60, or the slots for the large L-brace 30 may be closer to the inserted end 60 than the slots for the small L-brace 25. The corners 70 of the inserted ends 60 of the flat plates may be rounded, angled, or tapered to facilitate insertion of the flat plates into the joining objects. The inserted ends 60 include an insertion edge that may directly intersect the short edges and long edges of the plate, or may connect via the tapered or rounded corners. FIG. 3 shows a side view of two brackets and illustrates how the junctions 45 of the four plates are co-planar in a geometric plane 51 and would also intersect if continued beyond the bracket.

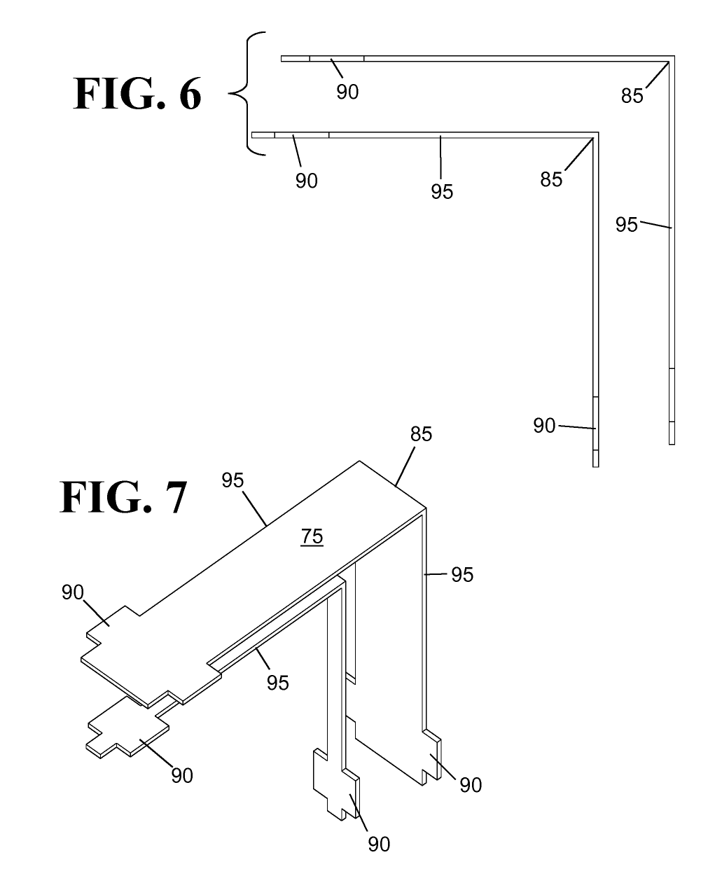

The small L-brace 25 and large L-brace highlighted in FIGS. 6 and 7 each include a first flat sheet 75 secured to a second flat sheet 80 at a right angle junction 85. As show in FIG. 6, the first flat sheets 75 of the small and large L-braces extend parallel to each other while the second flat sheets 80 of the small and large L-braces are also parallel to each other.

Each flat sheet also includes at least two knobs 90 extending out from the flat sheet and configured to interconnect with the slots 65 of the L-brackets. These knobs act to keep the L-braces properly positioned next to the L-brackets. The separations of the knobs 90 on the first flat sheets 75 is identical to the separation of the knobs 90 on the second flat sheet 80, however within flat sheets the separation of knobs on the small L-brace 25 is substantially less than the separation of knobs on the large L-brace 30.

The sidewalls 95 of the L-braces are configured to press against the L-brackets to properly space the L-brackets for insertion into joining pieces. Additionally, when the L-brackets are being inserted into the joining pieces, the sidewalls 95 of the L-braces prevent the flat plates of the L-brackets from bowing inward.

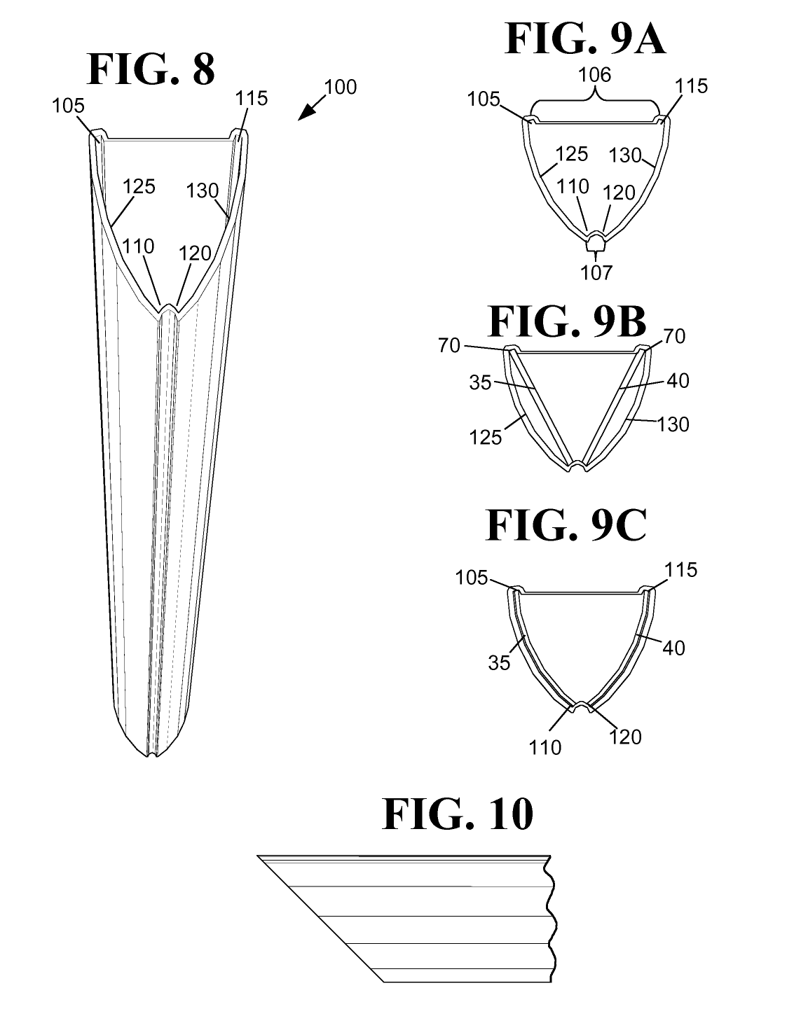

FIG. 8 shows a perspective view of a table leg or joining piece 100 while FIG. 9A shows a top view of the joining piece 100. The joining piece includes a cavity with a left upper slot 105, a left lower slot 110, a right upper slot 115, and a right lower slot 120. The left upper slot 105 is separated from the right upper slot 115 by an upper distance 106. The left lower slot 110 is separated from the right lower slot 120 by a lower distance 107. The upper distance 106 is substantially greater than the lower distance 107.

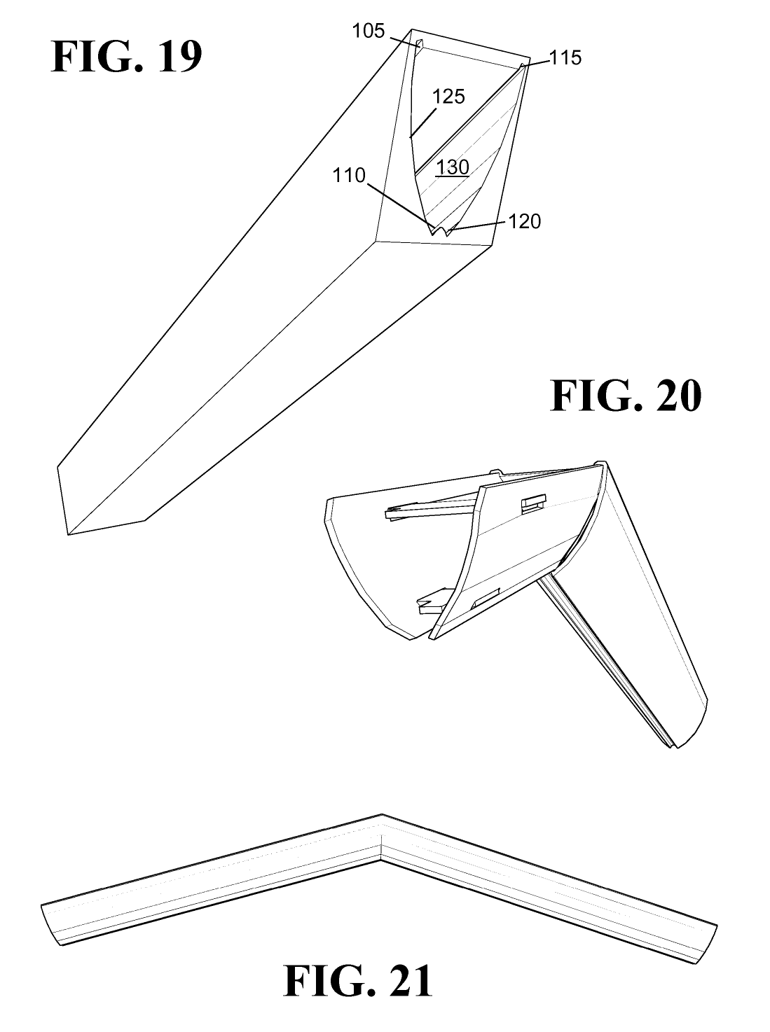

Between the left upper slot 105 and the left lower slot 110 extends a left concave surface 125. Between the right upper slot 115 and the right lower slot 120 extends a right concave surface 130. FIG. 10 shows a side view of the joining piece 100 and highlights the mitered end. In the illustrated example, the joining piece has an end mitered at a 45 degree angle so that two joining pieces secured together form a right angle. However, other angles may be used to accommodate various designs. For the joining piece shown in FIG. 8, the exterior shape reflects the interior shape of the cavity designed to accept the compressible fastener, however alternative decorative exterior shapes may be used, such as the rectangular shape shown in FIG. 19.

FIG. 9B illustrates a top view of a first L-bracket 15 and a second L-bracket 20 being inserted into a joining piece 100. In FIG. 9B, only the portion of the flat plates between the tapered corners 70 of the flat plates (35 or 40) have been inserted into the joining piece or table leg. The slots (105, 110, 115, 120) of the joining piece are substantially more rigid than the flat plates of the fastener. As the plates are pushed further into the joining piece, the flat plates become bowed outward because the separation of the upper slots (105, 115) from their respective lower slots (110, 120) is less than the width of the flat plates. The small and large L-braces (25, 30) prevent the flat plates from bowing inward as they are inserted into the joining piece, so the flat plates are bow outward and adapt the shape of the left and right concave surfaces (125, 130) as shown in FIG. 9C. If removed from the joining piece, the flat plates will substantially return to their flat shape. While inside of the joining pieces, the flat plates exert substantial forces on the slots (105, 110, 115, 120) of the joining piece to secure the compression fastener within the joining piece. In some embodiments, extremely flexible materials may be used for the compression fastener that would allow the fastener to be removed from the joining piece without the aid of specialized instruments or machinery, however in an exemplary embodiment the flat plates are constructed from resilient metal so that removal of the compression fastener from the joining piece without specialized equipment is nearly impossible.

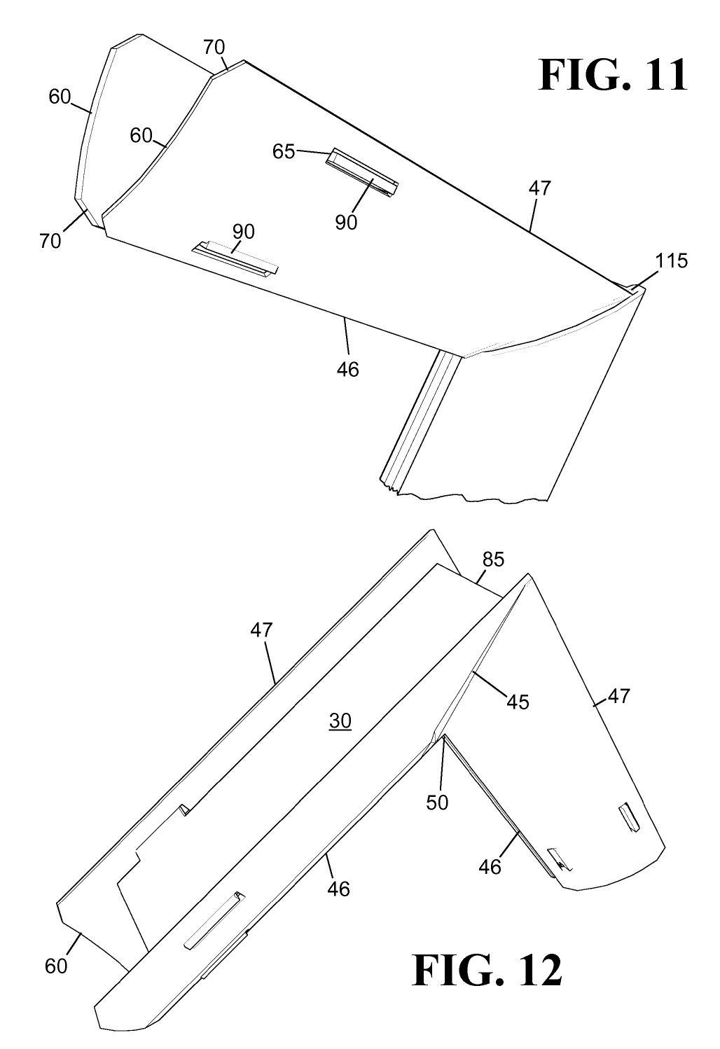

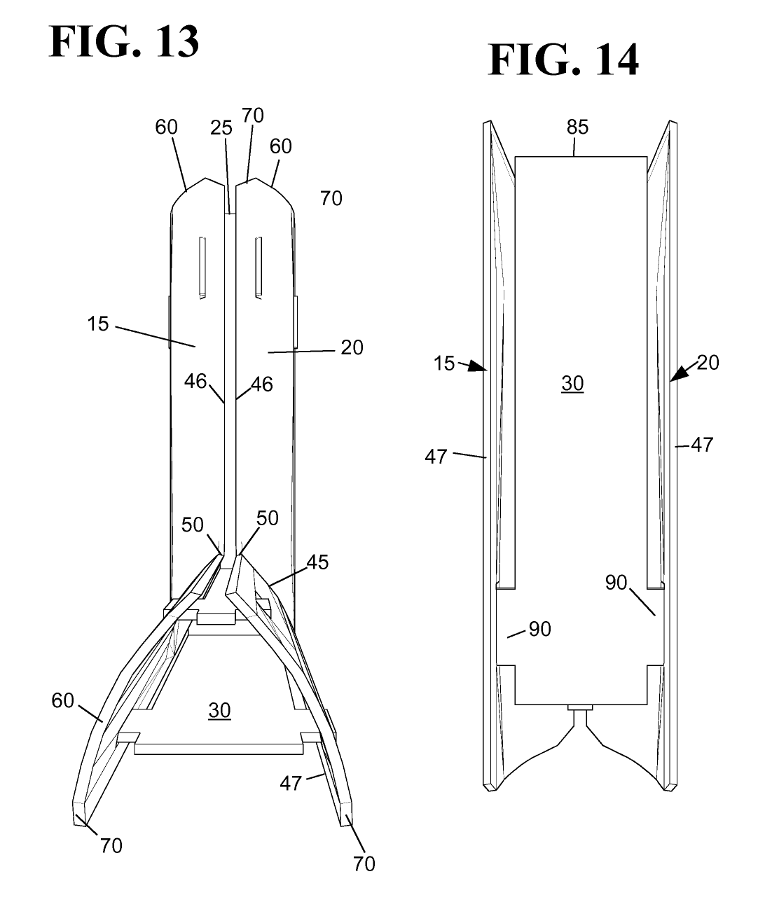

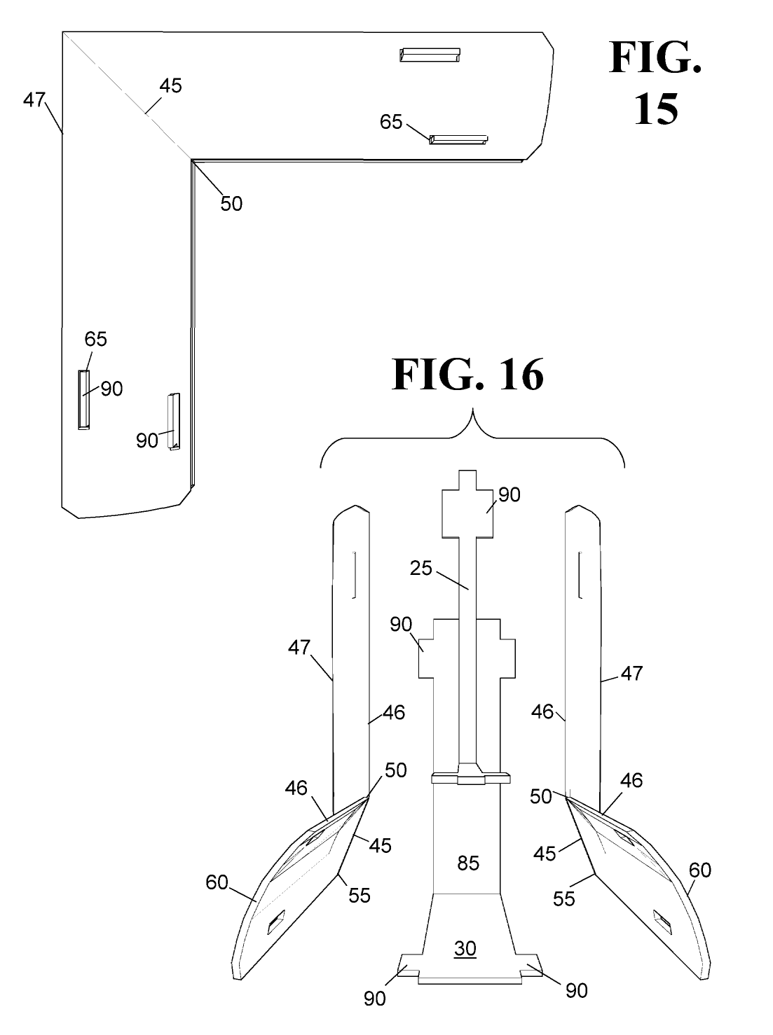

FIG. 11 shows a perspective view of a compressible fastener secured in a joining piece. FIGS. 12 through 16 show an isolated four piece compressible fastener with flat plates that have been bowed. For illustrative purposes, all the flat plates are shown in their bowed configuration despite the flat plates only adopting the bowed configuration while in the joining pieces. The knobs 90 of the small and large L-braces (25, 30) are configured to nearly contact or lightly press against the interior cavity of the joining piece as the four piece compression fastener is inserted into the joining piece. Substantial pressure is not exerted upon the knobs as they may be constructed from similar material as the L-brackets (15, 20) which are deformed when inserted into the joining pieces. As the four piece compression fastener 10 is inserted into a joining piece, the bowing of the flat plates causes the slots 65 of the plates to move along the knobs toward the left and right concave surfaces (125, 130). When two joining pieces are secured together with a four piece compression fastener, the L-brackets provide most of the support to prevent the joining pieces from twisting or bending relative to each other, however the small and large L-braces add a bit of structural rigidity to prevent the joining pieces from twisting relative to each other.

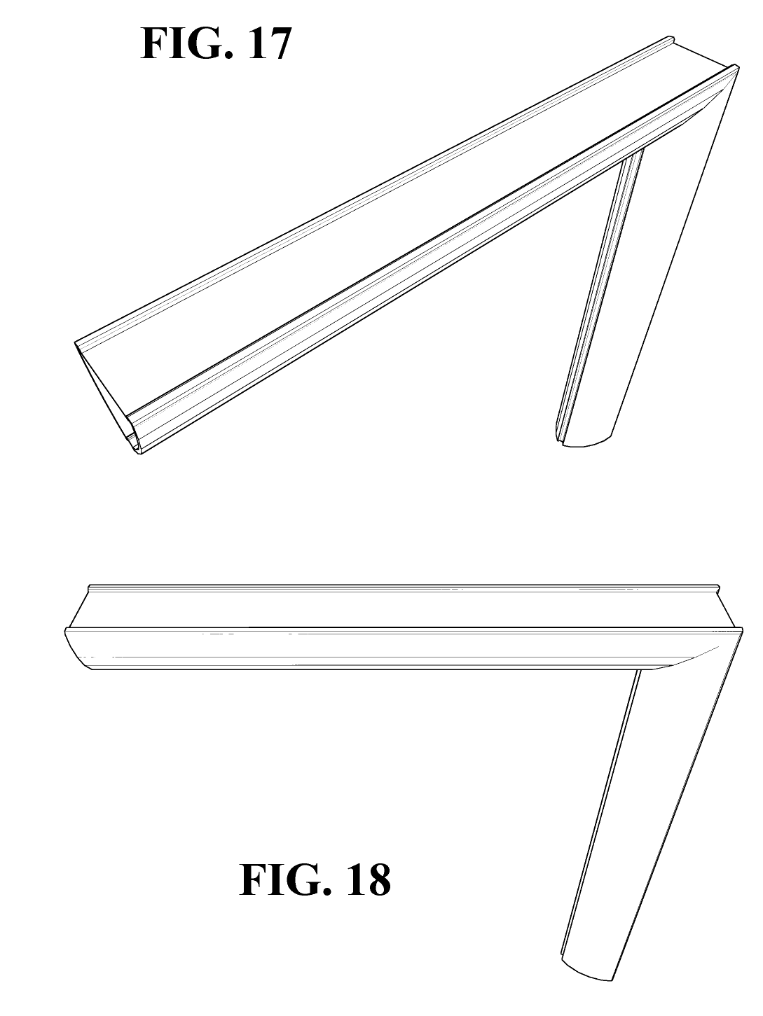

FIGS. 17 and 18 show two joining pieces with mitered ends that are secured together at right angles to each other. When two joining pieces are secured together with the compression fastener, they encircle the compression fastener and may cooperate to fully enclose the compression fastener so that it is not visible from any angle of view.

FIG. 19 illustrates an alternative embodiment of a joining piece or table leg. While the other table legs illustrated in the application have an exterior surface that substantially mirrors the interior surface adapted to receive the four piece compression fastener, the exterior surface of the table leg in FIG. 19 is completely unique from the portion adapted to receive the compression fastener. While a rectangular exterior surface is shown in FIG. 19, it should be appreciated that various embodiments may use almost any exterior shape or design.

FIGS. 20 and 21 illustrate an embodiment with joining pieces secured together with a compression fastener at greater than a 90 degree angle. Various embodiments may include joining pieces secured together at angle substantially greater, or substantially less than 90 degrees. In creating non-right angle connections, the interior right angle 50 of the L-brackets, the exterior right angle 55 of the L-brackets, the angle of the junction of the L-braces 85, and the angle of miter on the joining pieces are varied to create robust connections at a myriad of angles.

FIG. 22 illustrates an example of two flat plates than have not been bent at a junction. Before the plates are bent at a junction, the inserted ends 60 of the flat plates are not perpendicular to each other as they are in the four piece fastener shown in FIGS. 1 through 5. Additionally, the angles that will become the interior right angle 50 and the exterior right angle 55 are not at right angles. It is through bending at the junction between the two flat plates that the L-bracket achieves the design shown in FIGS. 1-5. While the unbent version of the L-bracket lacks structural rigidity of the fully formed L-bracket, the unbent version is flat and may take up less space when large quantities of brackets are being shipped.

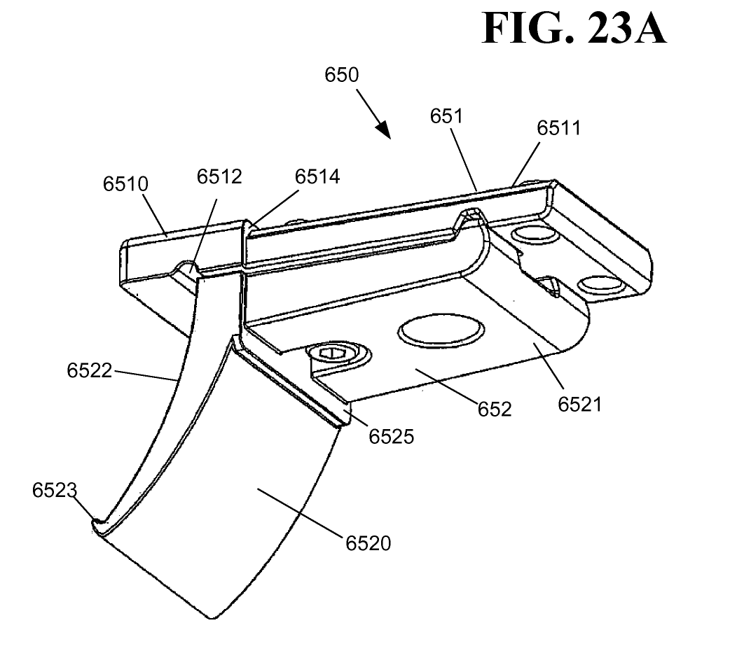

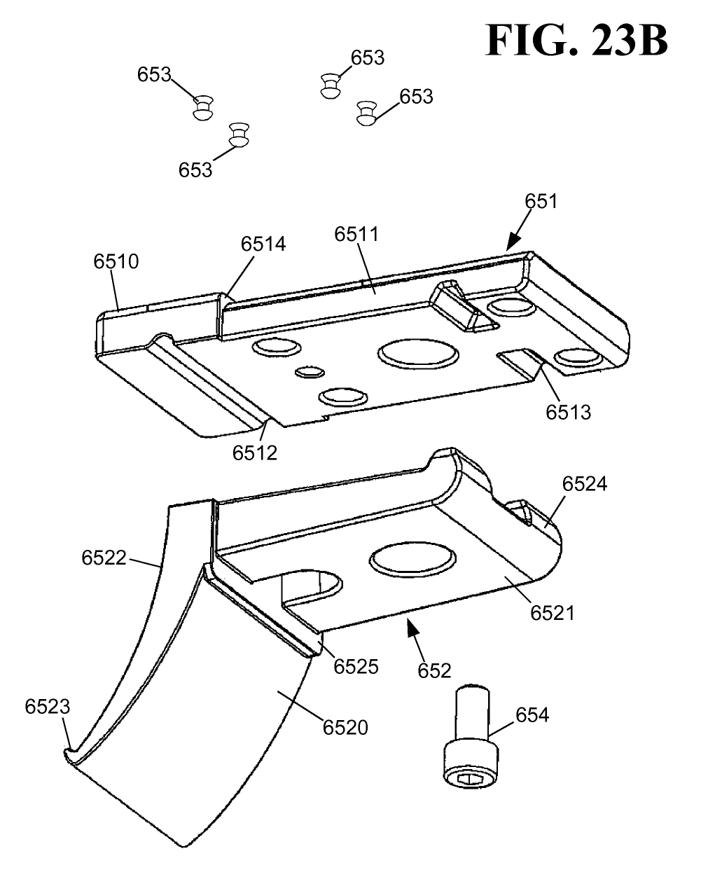

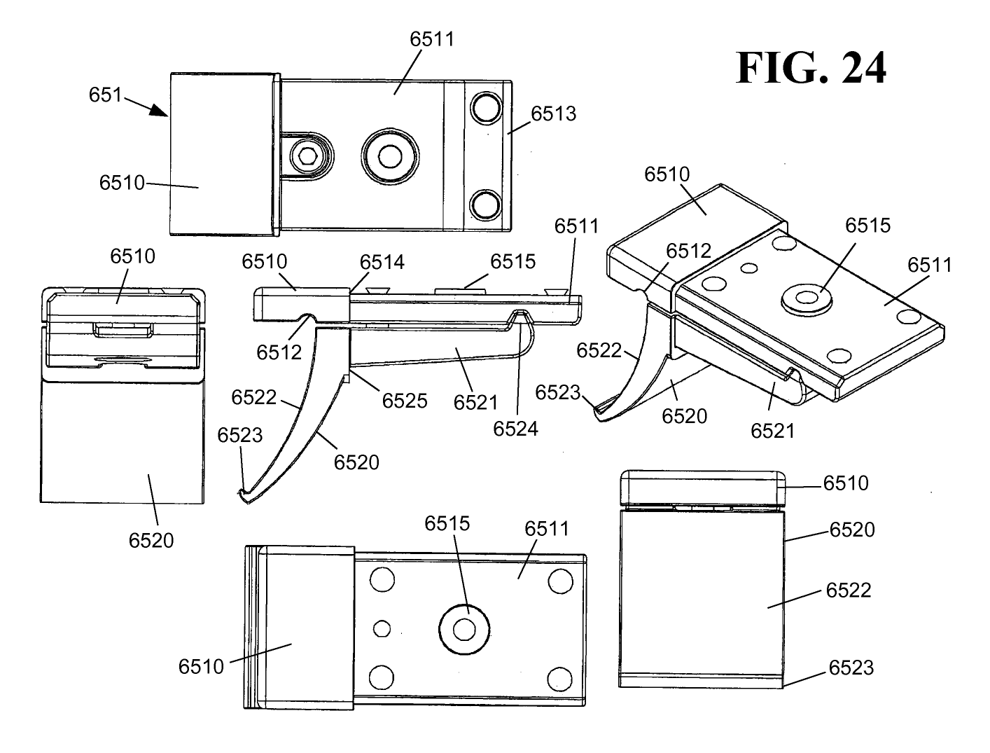

FIGS. 23A, 22B, and 24 show the coupling unit 650 in more detail. The coupling unit 650 is used to connect two struts, and in particular two support struts. The coupling unit 650 includes a claw-like portion that is configured to clamp onto the table leg.

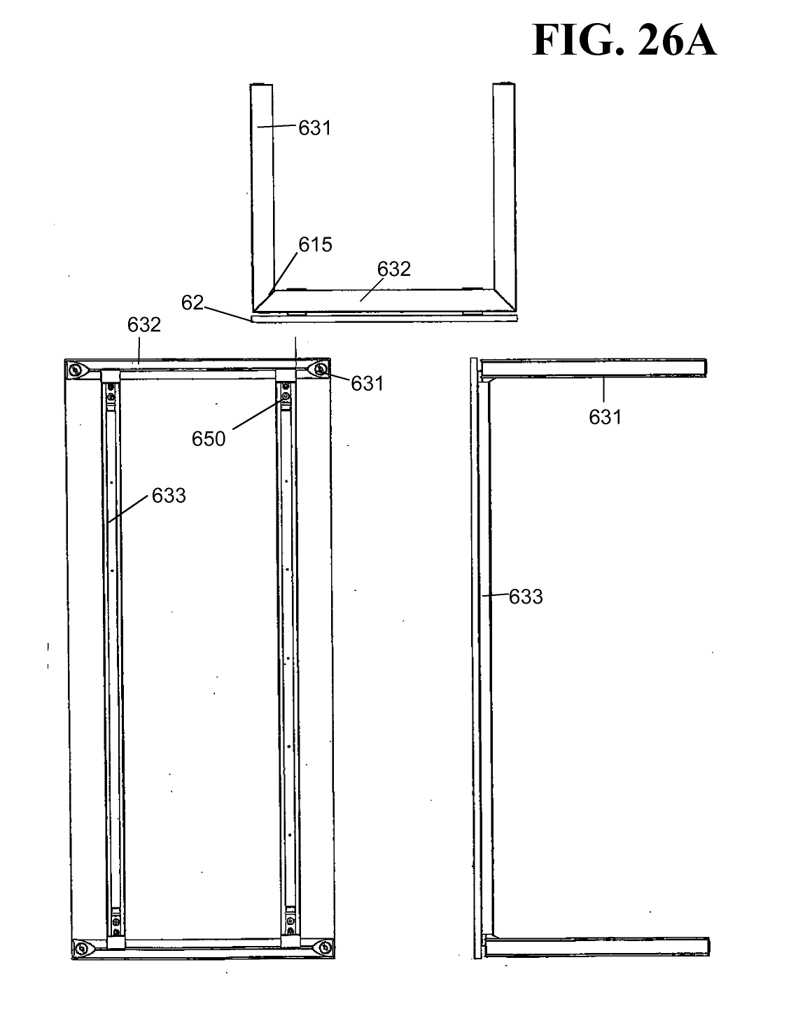

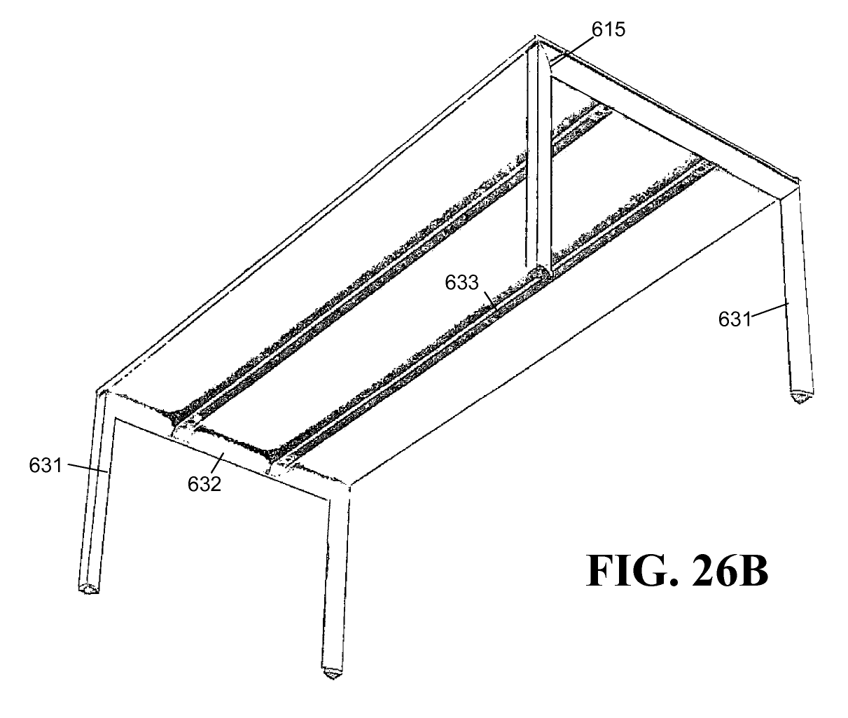

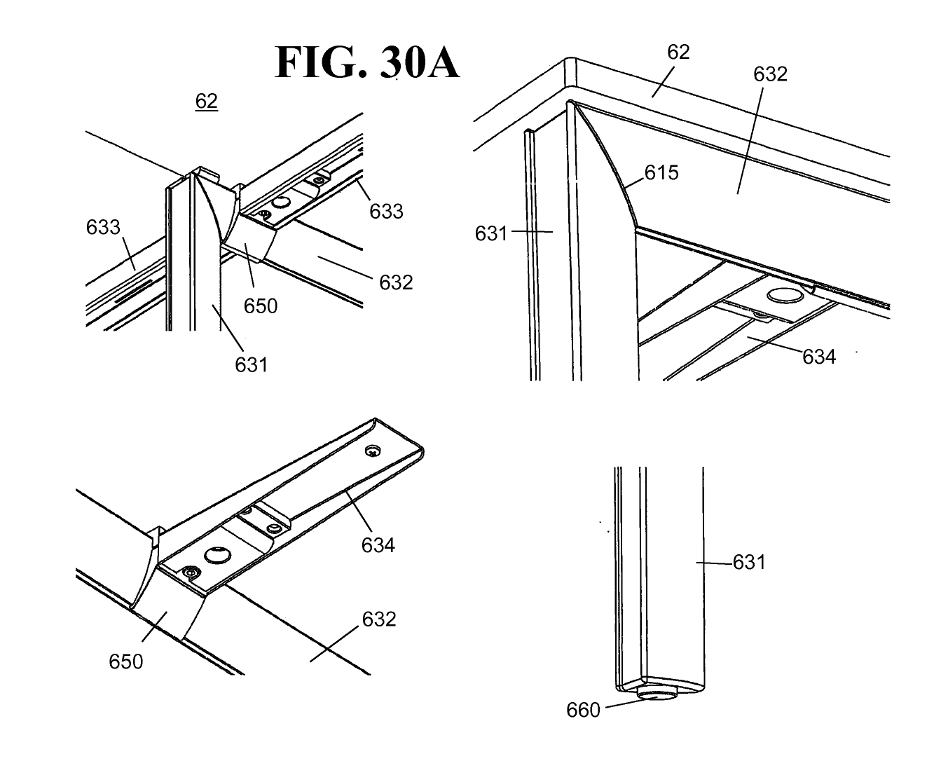

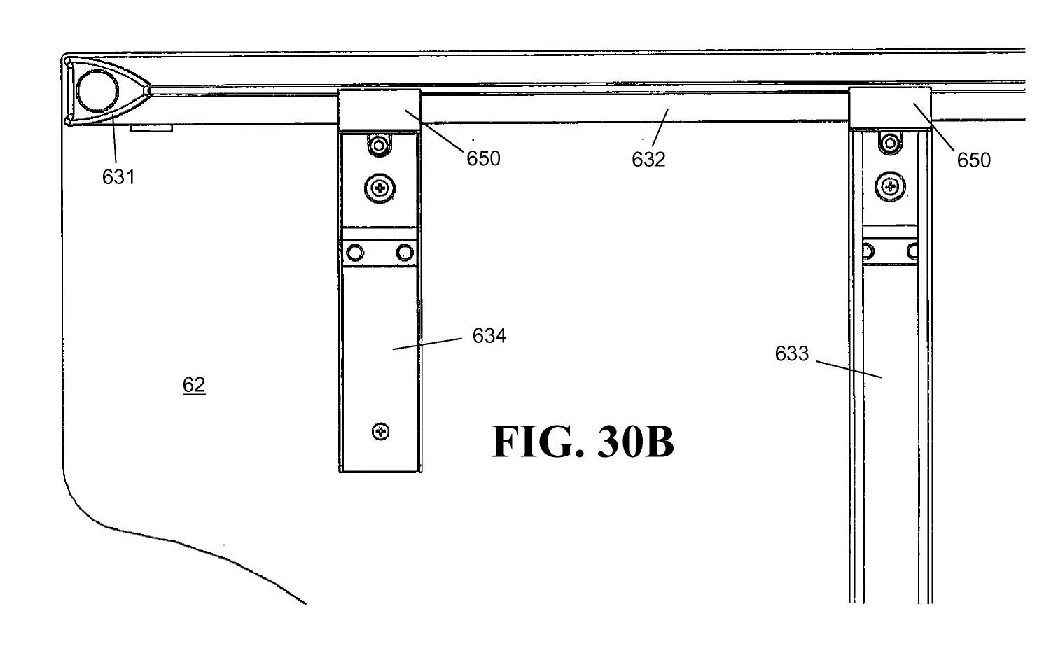

The coupling unit 650 has a first and second coupling part (651, 652) or member which are clamped together to form a receiving portion. The first and second coupling part 651, 652 are drawn together by means of a clamping element 654 (a screw in the illustrated example). The first coupling member 651 (or top coupling member) is mounted to the table top, the cross beams, or struts 233 (shown in FIGS. 26B, 30A, and 30B) by retaining means 653, such as rivets or screws. This strut forming longitudinal member 633 is advantageously a U-shaped or C-shaped metallic support rail. The longitudinal member may be made of steel. The first clamping portion 6510 of the first coupling member 651 preferably has outwardly projecting features 6514 for receiving parts of the longitudinal member 633. The outer parts of the first clamping portion 6510 are configured to have a shape similar to that of the longitudinal member 633 in order to minimize the appearance of a seam at the clamping member.

The first coupling member also includes a mounting projection 6515 that, in the illustrated example, is the shape of a coin and acts to help secure the coupling unit in the longitudinal member 633. Through a screw hole in the center of the mounting projection 6515 a fixing screw can also be guided. The bottom of the first clamping portion 6511 has a recess for receiving a nut. The nut can be threaded through the coupling unit 650 and pressed against the longitudinal member 633 in order to further secure the two items together.

The bottom of the first coupling member 651 has a positioning seat 6513 or seats in the form of a groove-like, conical recess that is configured to secure upwardly projecting locating lugs 6524 of the second coupling member. The lugs 6524 also have a conical shape such that the first and second coupling members are able to pivot relative to each other at the positioning seat lug joint.

The second clamping portion 6521 in its rear region may have a stop 6525 for contacting a bottom part of the longitudinal member 633, or strut. The second coupling member 652 also includes a contoured portion 6522 that has a shape complimentary to the table leg or joining piece. At the lower end of the contoured portion 6522 is an upwardly projecting nose clamp 6523 that is integrally formed on the second clamping portion 6520. The nose clamp 6523 is configured to engage the channel in the table leg or joining piece. On the first coupling member 652, a groove 6512 extending parallel to the nose clamp is formed. The groove 6512 is adapted in shape and position to interact and secure the protrusions in the joining piece associated with the left and right upper slots. When the tensioning element 654 is engaged, a stable clamping attachment is obtained. By loosening the tensioning element 654 the longitudinal members 633 may be easily moved in to a desired position and fixed there.

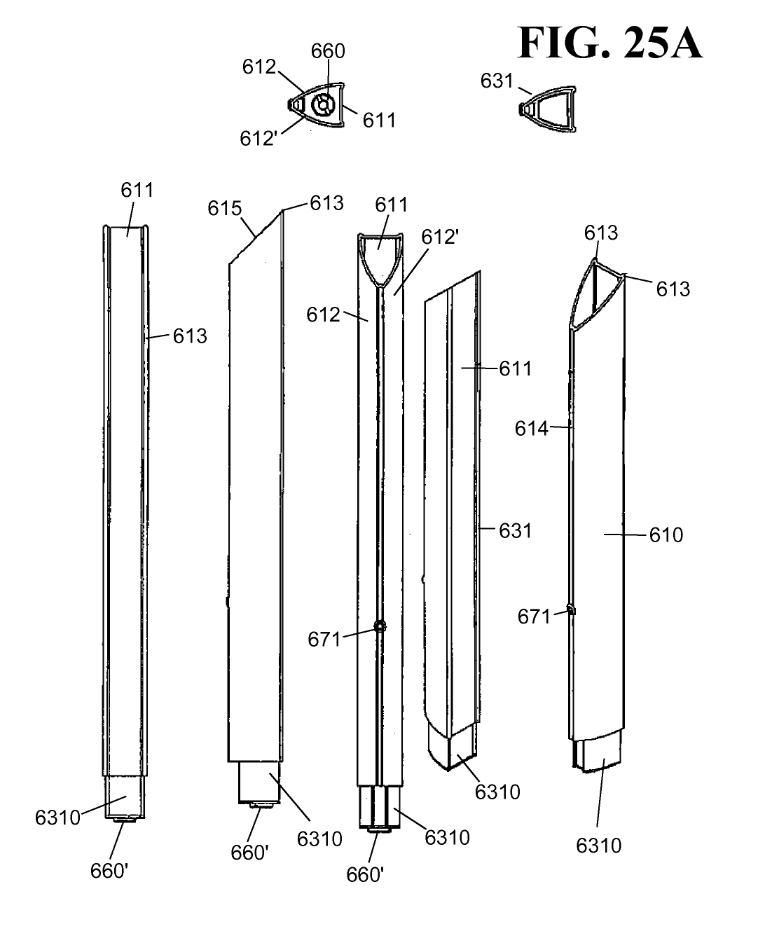

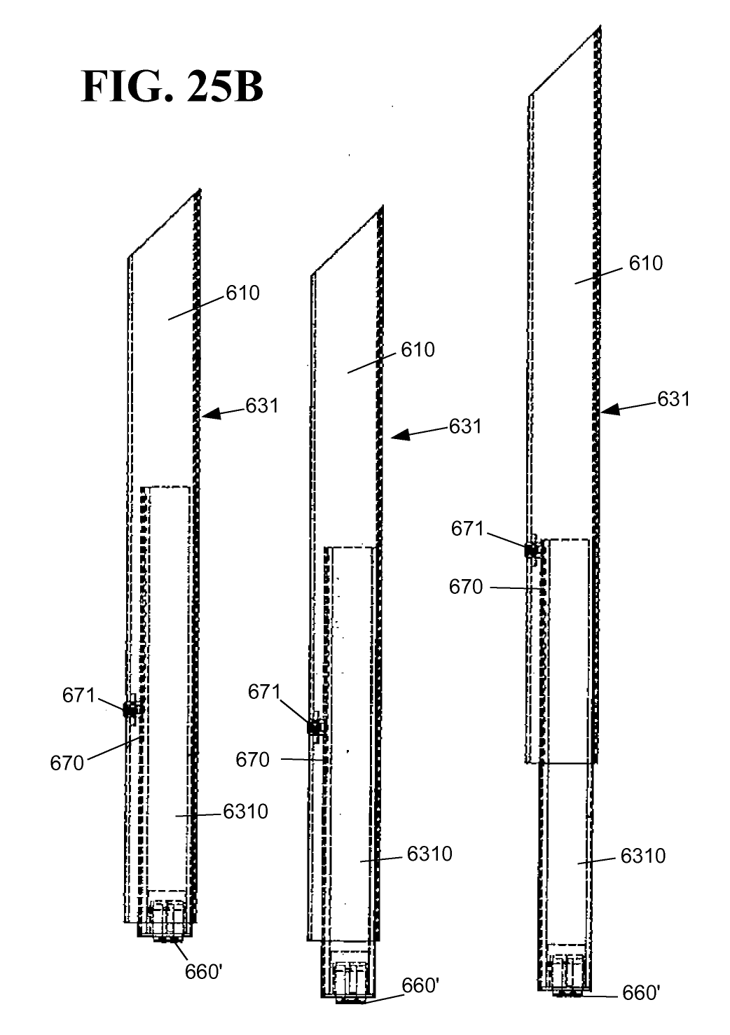

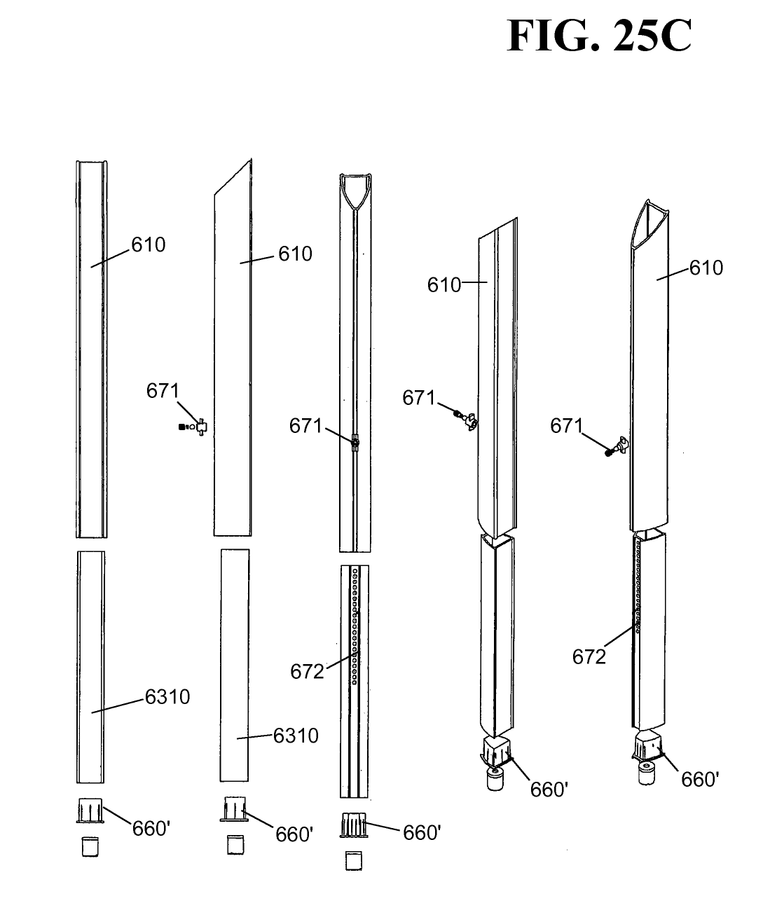

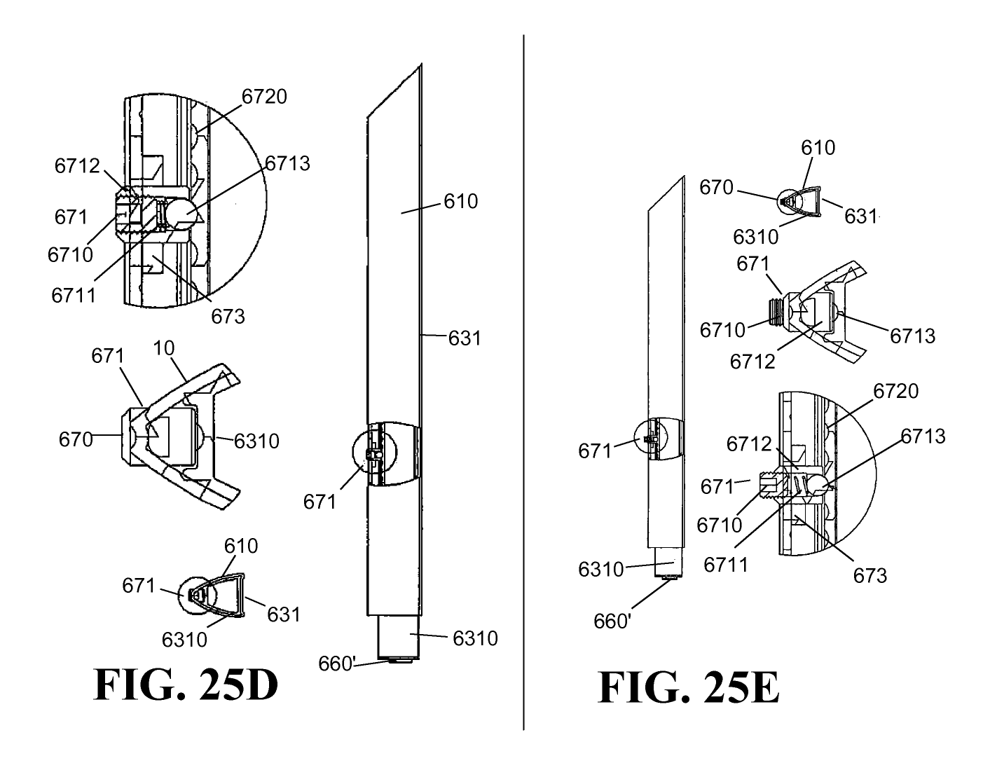

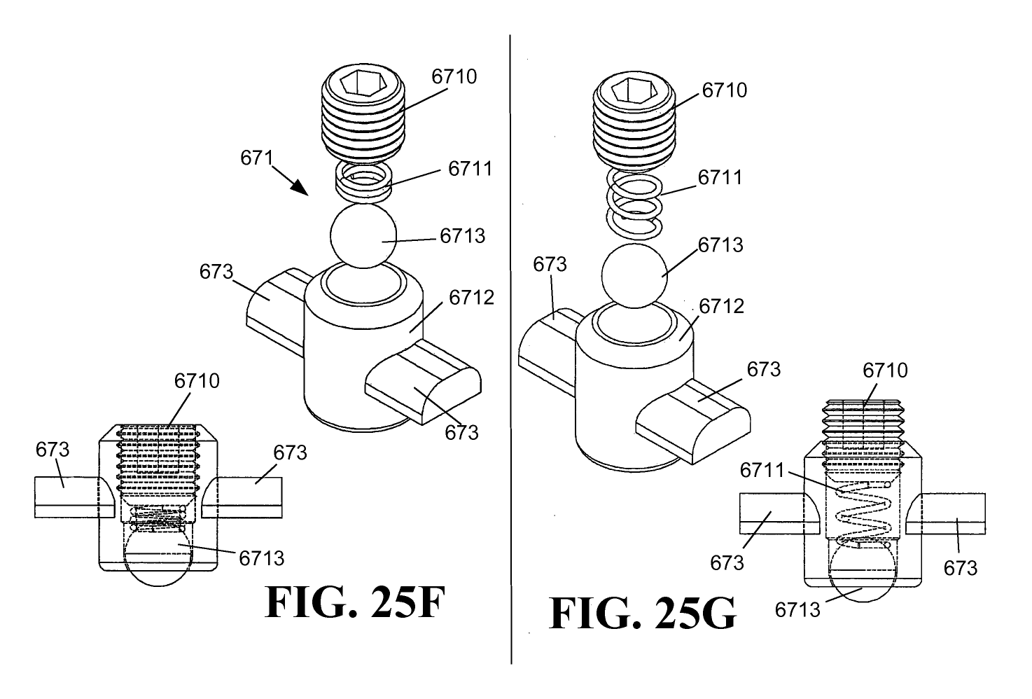

In FIGS. 25A to 25G, a height adjustment 670 for the table legs 631 is shown. An outer support portion of the leg 631 is displaceable in the longitudinal direction relative to an extension section 6310. The desired height of the table leg is selectable by engaging a locking mechanism 671. In the illustrated example, the locking mechanism 671 is aligned with a depression 614 in the leg. The locking unit 671 is used with a sleeve-shaped housing perpendicular to the longitudinal direction of the strut 610. The locking unit includes an adjustable support screw 6710 that acts upon a spring 6711 pressed against a retaining member 6713 that is in the shape of a ball in the illustrated example.

The extension section 6310 has a holding element 672 that extends up and down, and is configured to interact with the locking unit 671. In the illustrated example, the holding element is a row of rounded tooth cavities or recesses into which the spring-loaded retaining member 6713 may be engaged. If the support screw 6710 is unscrewed sufficiently, the support member 6713 can come out of one of the recessed features 6720 in the holding element 672 and snap back into another of the many recessed features 6720 on the holding element. In the example shown, the holding element 672 is directly incorporated into the wall of the extension section 6310. The structure allows for simple height adjustment while providing a stable platform while in the locked configuration.

Once the support screw 6710 is sufficiently pressed against the spring 6711 the support member 6713 cannot come out of the holding member 6720 and blocks the up and down movement of the extension section 6310 so that a secure height adjustment is obtained. Small height leveling may be performed using a foot unit 660 in the designed leveling mechanism. The foot unit 660 may be configured to extend outwards when the foot unit is rotated relative to the extension section 6310.

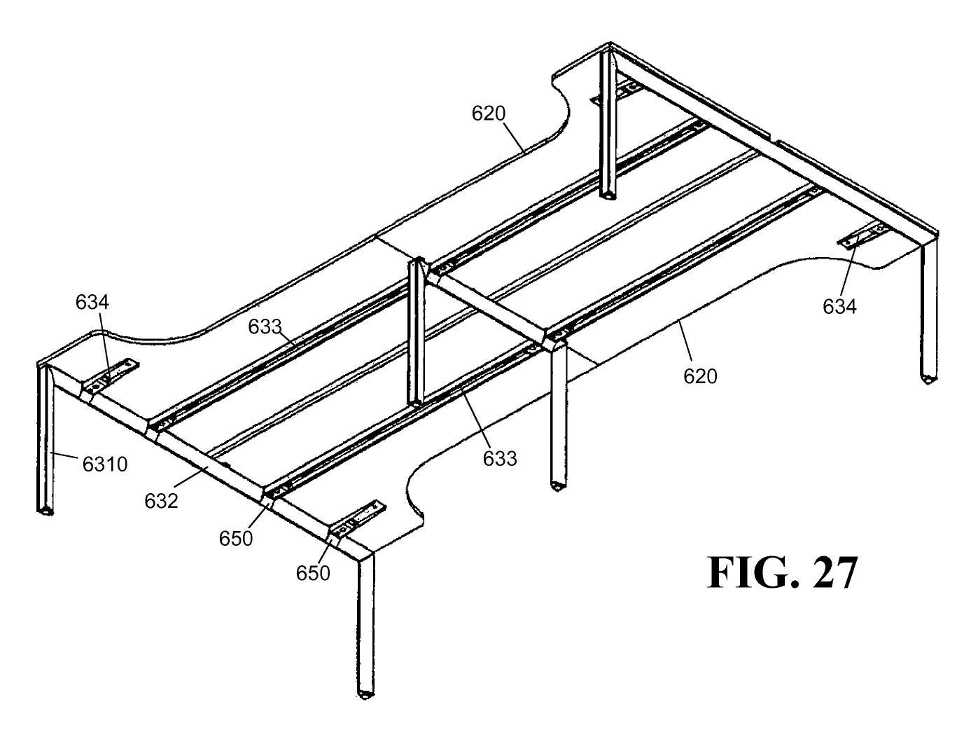

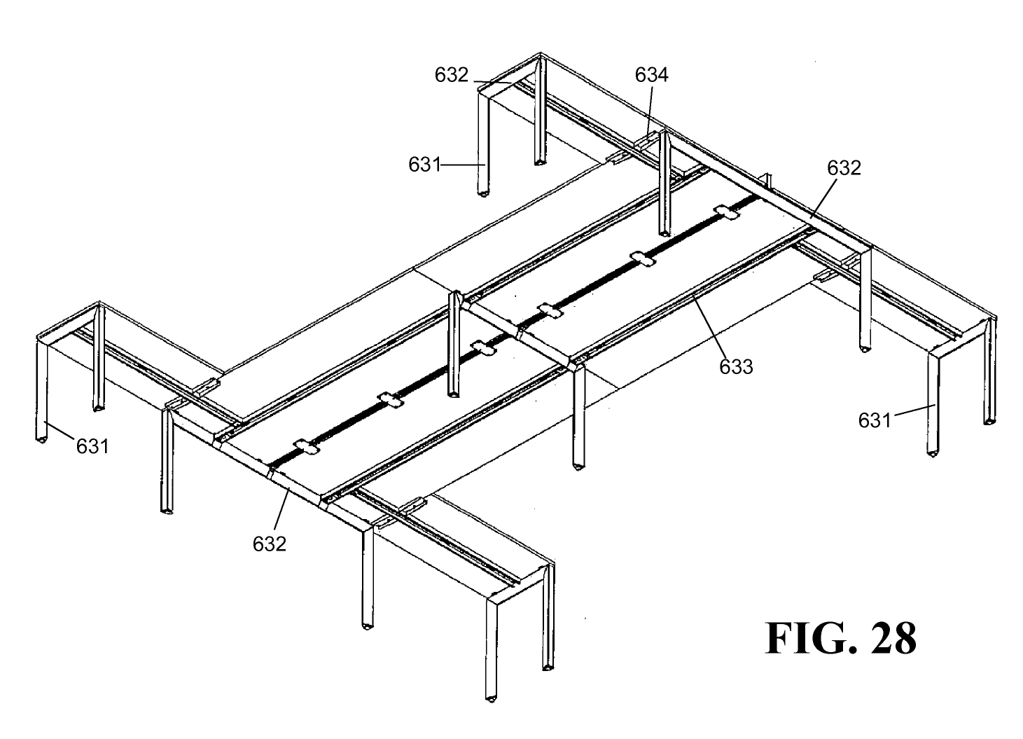

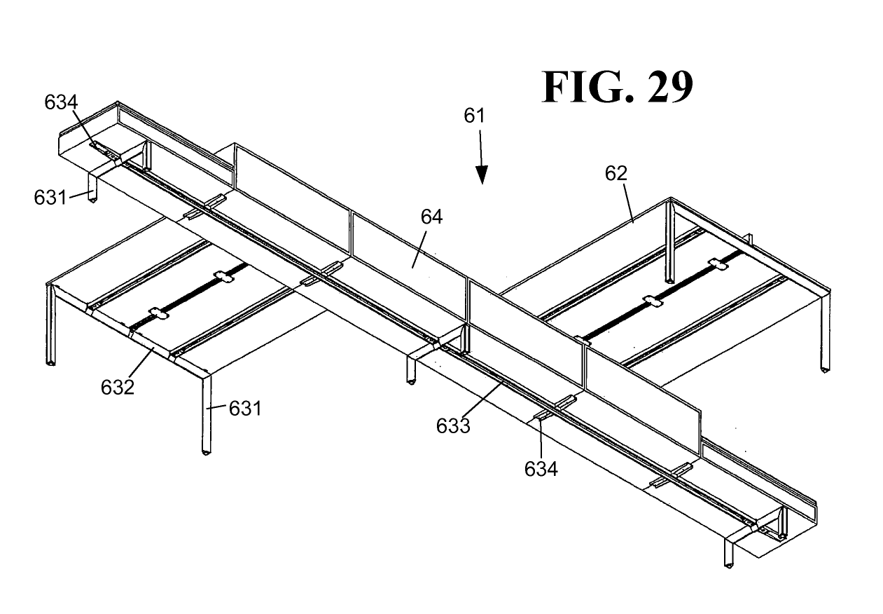

FIGS. 26A, 26B, 27, 28, 29 and 30 show different furniture systems, principally table systems, in which the above-described structural units are utilized. Various formations of profile bars 610, corner connectors 640, coupling units 650, connecting struts, and height adjustment units 670 are shown.

In FIG. 26 there are four coupling units 650 secured to the cross braces 632 and connected to longitudinal beams 633. The legs 631 are connected at the ends by means of inserted corner connectors. The cross braces 632 or joining pieces and the legs 631 are made of profile members 610 with the same cross section. In addition, other supporting arms may be attached to the cross member 632 for stabilizing the table. FIGS. 30A and 30B show details views of the previously described table system.

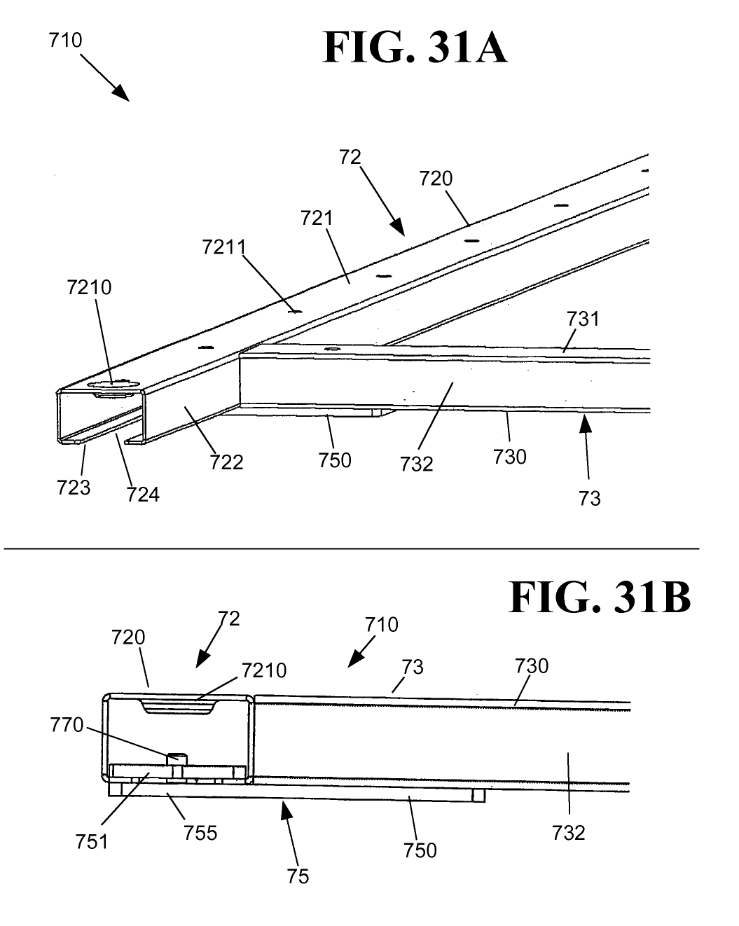

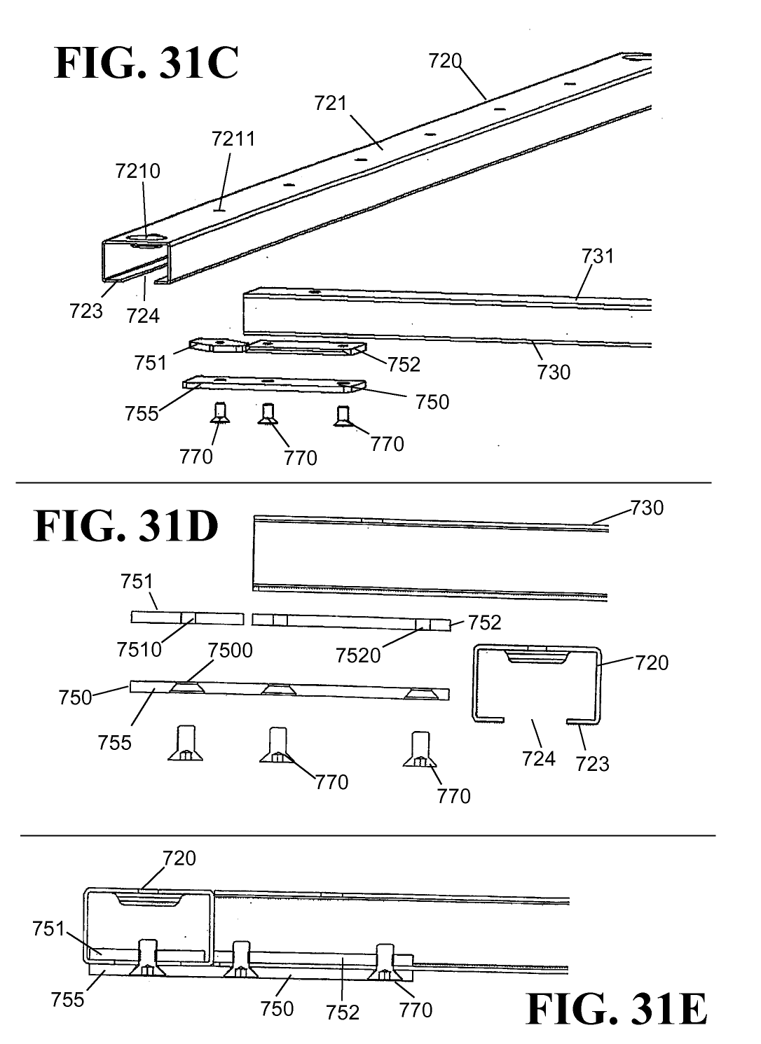

FIGS. 31A through 31E show a cross leg 72 secured to a cross brace 73 in a stable configuration with a connector 75. The profile of the cross leg 72 has a C-shaped, rectangular cross-section and is made of metal, preferably steel. The cross brace 73 has a similar profile. The constructional unit 710 is particularly applicable to a frame of a furniture unit, such as a frame for supporting a tabletop. In the illustrated example, the cross leg 72 includes a cross strut 720 and the cross brace 73 has a cross bar 730 that is parallel to the cross strut 720. The cross leg 72 also has a top wall 721 with parallel bent sides 722 extending perpendicular to the top wall 721. Inwardly extending from the bent sides 722 are base walls 723 that run parallel to the top wall 721. Between the base walls 723 is an elongated slot 724. In the top wall 721 there are one or more secure mounting openings 7210.

FIGS. 31A through 31E show a cross leg 72 secured to a cross brace 73 in a stable configuration with a connector 75. The profile of the cross leg 72 has a C-shaped, rectangular cross-section and is made of metal, preferably steel. The cross brace 73 has a similar profile. The constructional unit 710 is particularly applicable to a frame of a furniture unit, such as a frame for supporting a tabletop use. In the illustrated example, the cross leg 72 includes a cross strut 720 and the cross brace 73 has a cross bar 730 that is parallel to the cross strut 720. The cross leg 72 also has a top wall 721 with parallel bent sides 722 extending perpendicular to the top wall 721. Inwardly extending from the bent sides 722 are base walls 723 that run parallel to the top wall 721, and between the base walls 723 is elongated slot 724. In the top wall 721 there are one or more secure mounting openings 7210.

The connector 75 shown in FIGS. 31A to 31E includes a connection plate 750, an insert piece 751, a holding member 752 and a plurality of fastening elements 770, such as screws. To establish the right angle connection between the cross leg 72 and cross brace 73, the connector is mounted at a terminal end of the cross brace 73 while the connector may be secured at any part of the elongated slot 724 of the cross leg 72. The connection plate 750 spans both the cross leg 72 and the cross brace 73. The holding member 752 is inserted into the elongated slot 734 of the cross brace 73 and rigidly secured to the connection plate 750 with fastening elements 770. Between the holding member 752 and the connection plate 750 are sandwiched the base walls 733 of the cross brace 73. The tight connection of the plate and the holding member prevents the cross brace 73 from moving relative to the cross leg 72. Similarly, the insert piece 751 is inserted into the elongated slot 724 of the cross leg 72, secured to the connection plate 750.

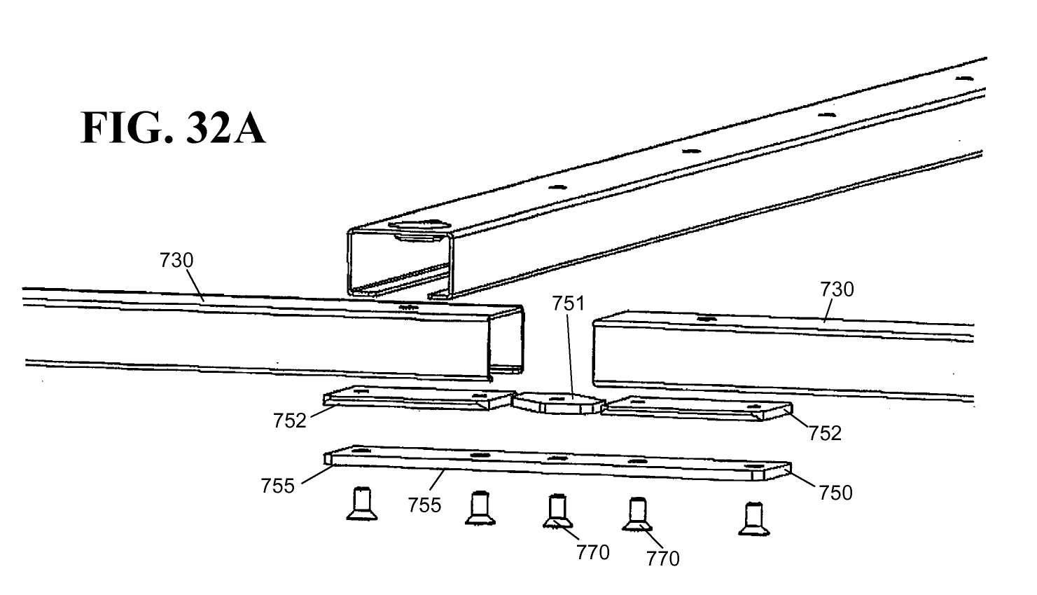

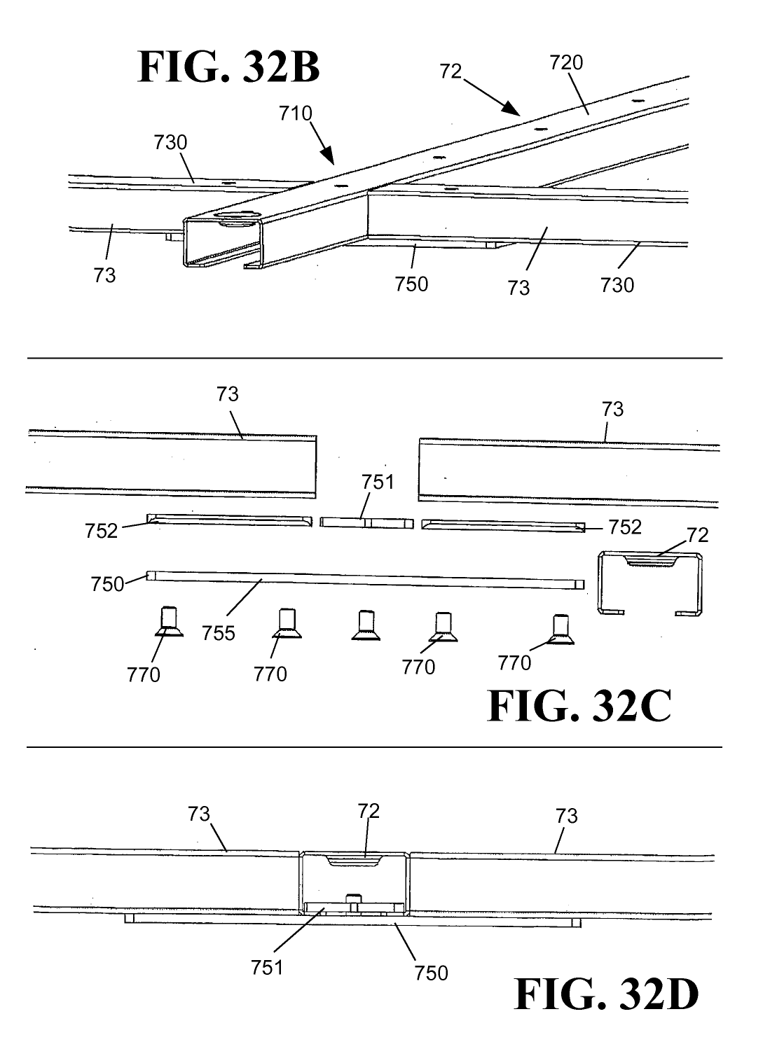

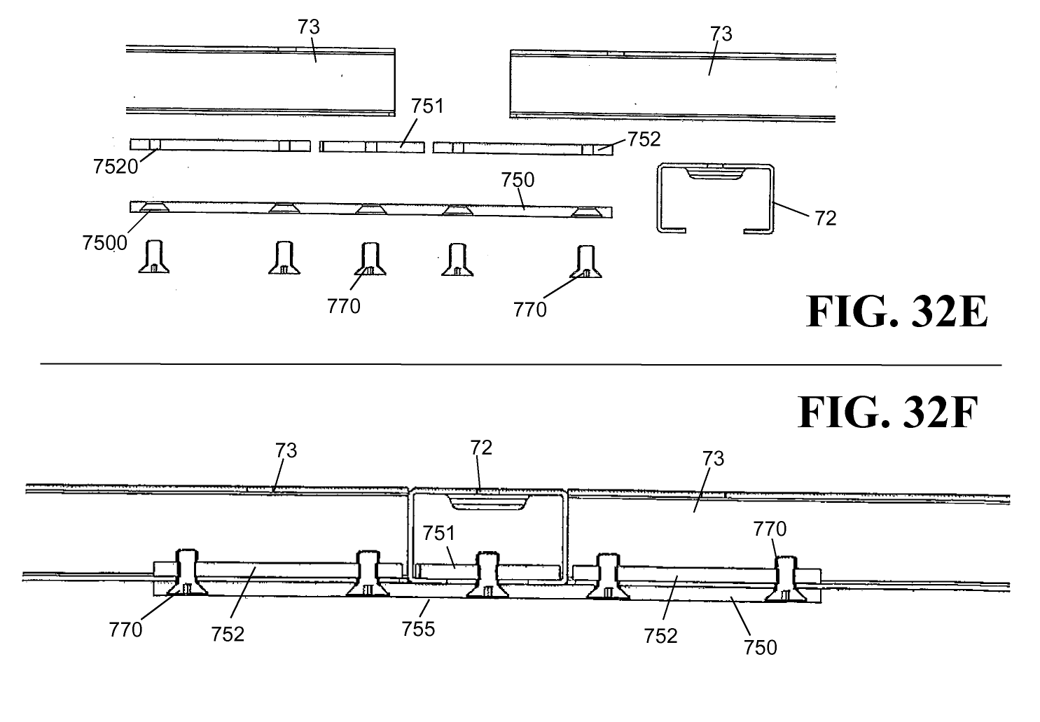

FIGS. 32A through 32F show another embodiment in which two cross braces 73 are secured to a single cross leg 72. In the illustrated example, a connector with a longer connection plate 750 is utilized. The holding members 752, the insert piece 751, and the fastening elements may be identical to those shown in FIGS. 31A through 31E.

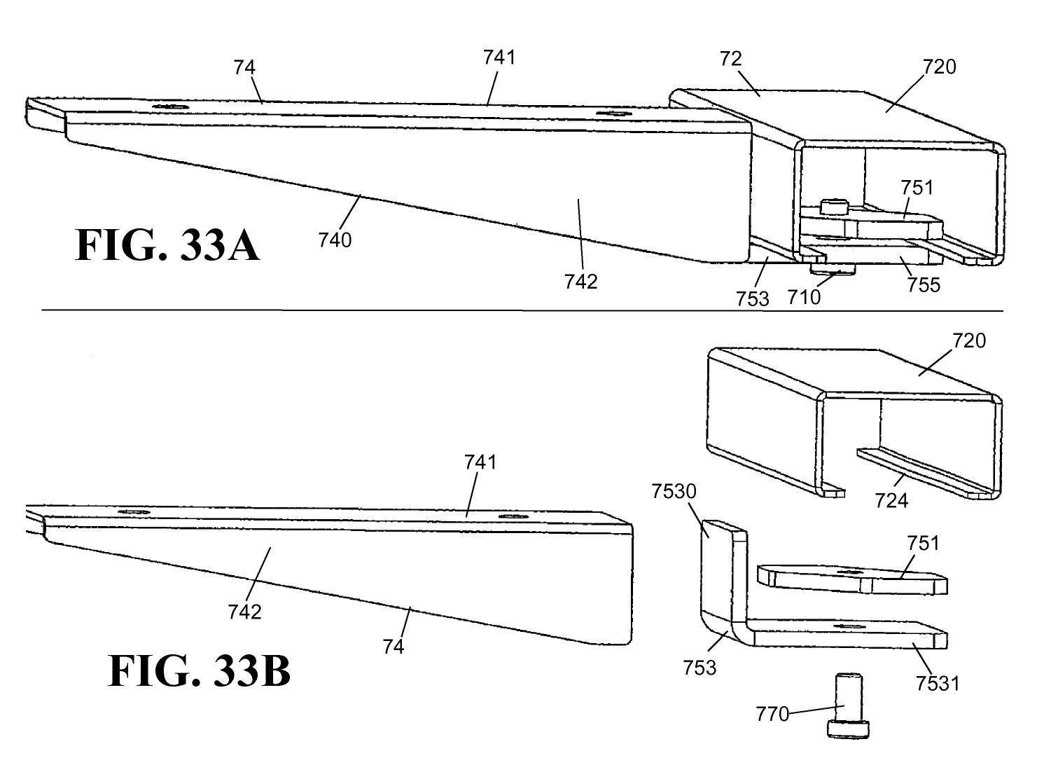

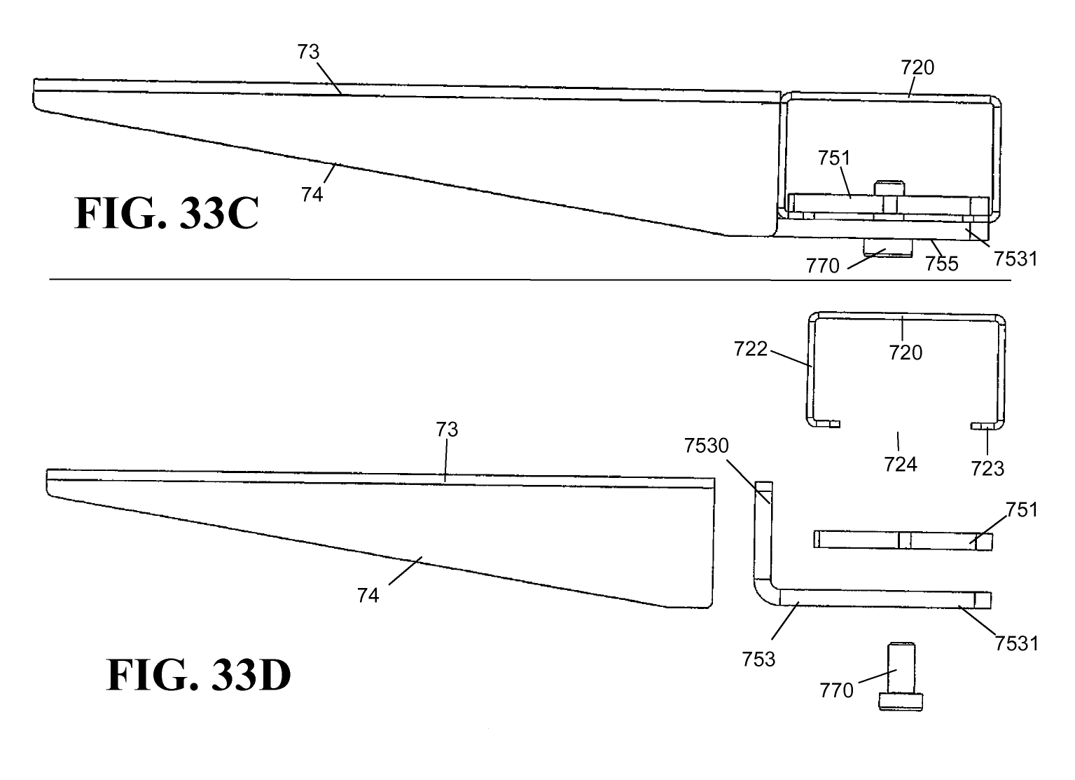

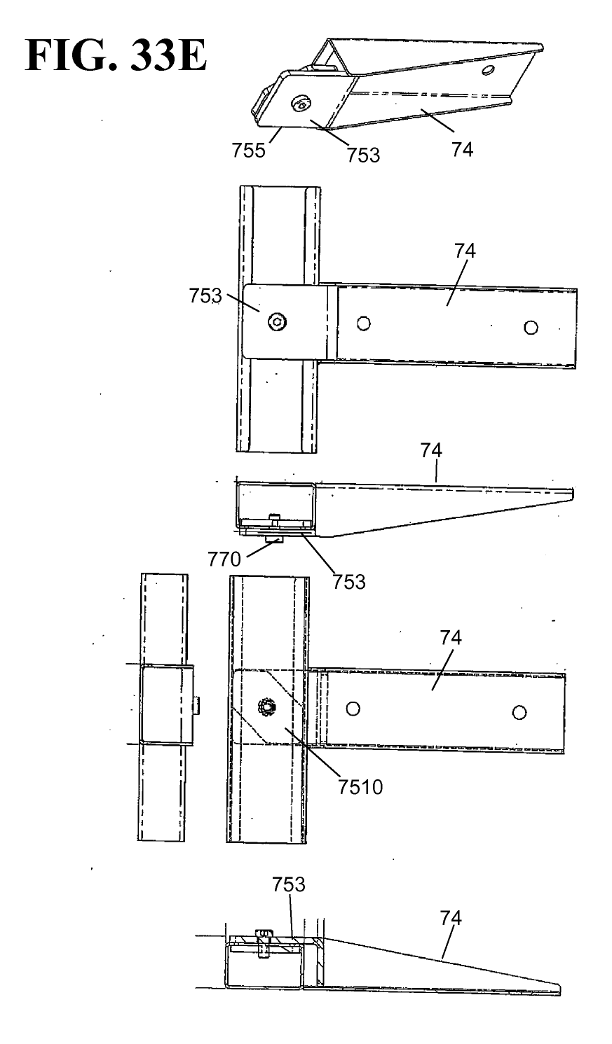

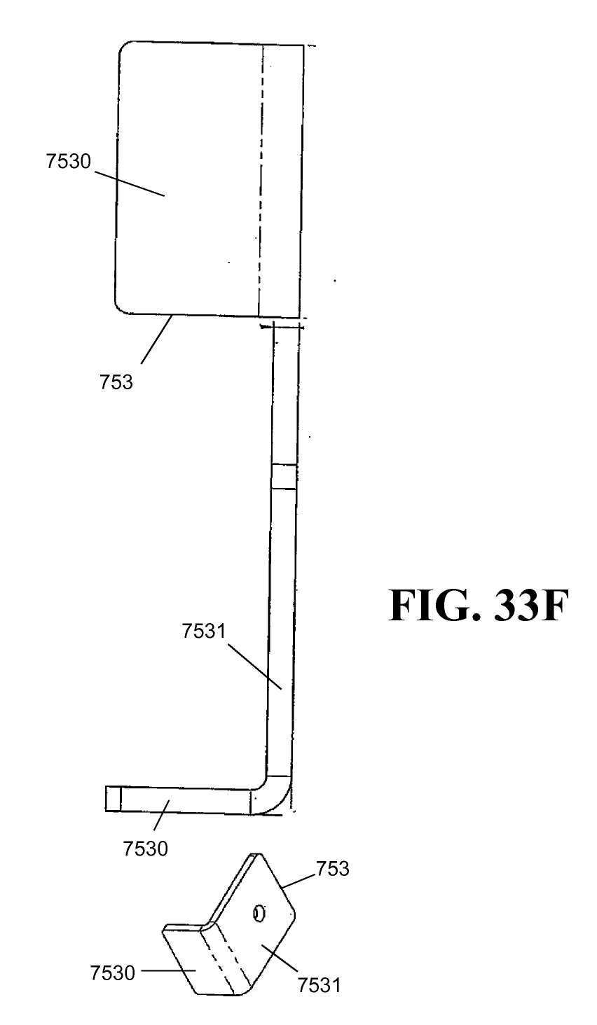

In the further embodiment shown in FIGS. 33A through 33E, the cross leg 72 has a corresponding profile cross section to the previous embodiments. However, instead of a cross brace 73, the cross leg is secured to an arm 74 usable to help support a table top. The arm 74 includes two triangular sidewalls 742 extending up to a top 741. In the illustrated example the base walls 723 contact and are secured to a connection piece 753 that has a rectangularly bent side leg 7530. The rectangularly bent side leg 7530 is connected to the arm 74 by means of welding. In a preferred embodiment, the side leg 7530 is inwardly offset from the edge of the top 741.

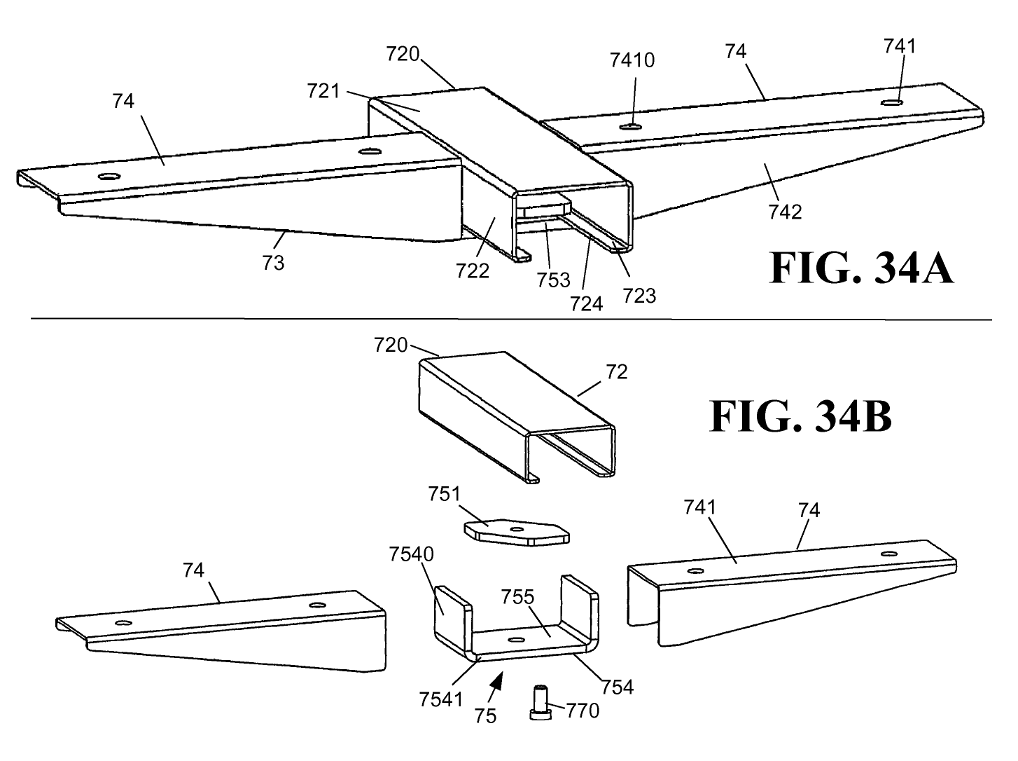

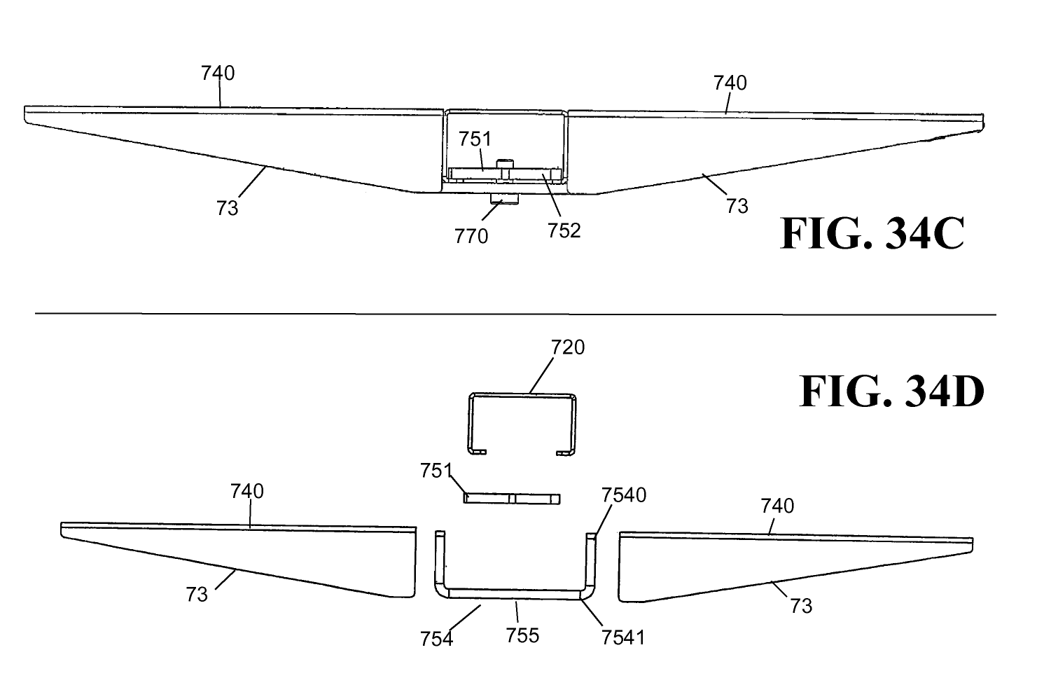

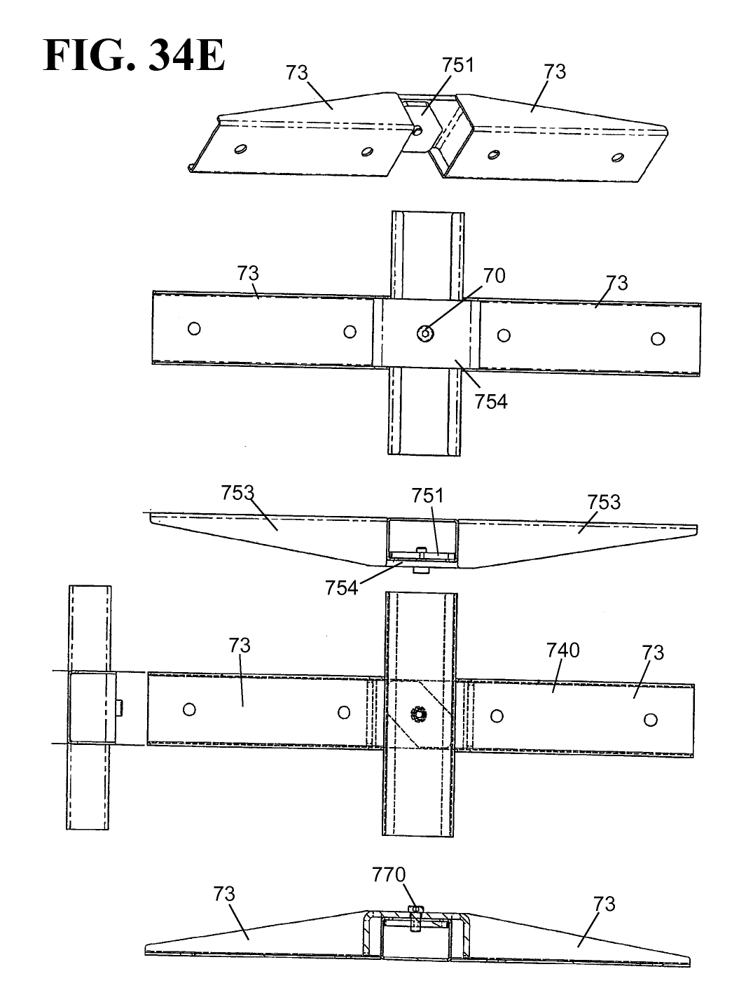

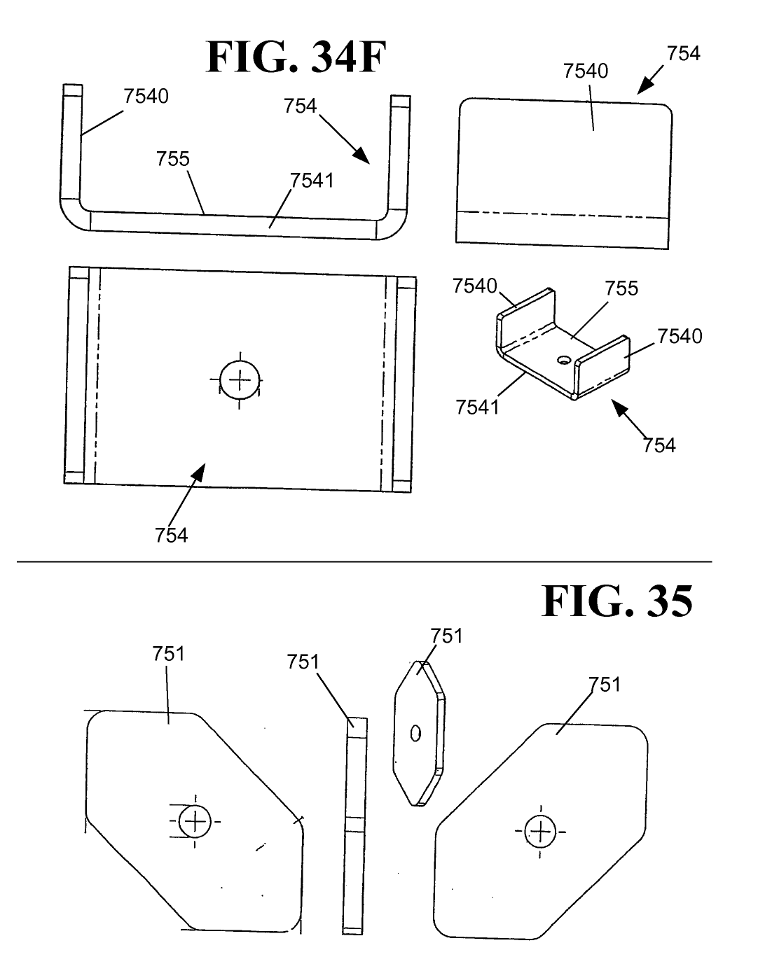

FIG. 33E shows various views of this embodiment of the unit. In FIG. 33F the connection piece 753, the side legs 7530, and a base leg are shown. FIGS. 34A to 34E show a further exemplary embodiment in which two arms are supported on opposite sides of a single cross leg.

In the illustrated example the separation between the two side legs 7540 is the same as the outer diameter of the cross leg 72 so that the pieces may be easily connected to each other. The bridge 7541 is clamped by a fastening means 770 to the insert piece 751. As with the previous embodiments, top wall 741 of the arm 74 includes attachment holes so that items (such as a table top) may be secured to the assembly.

Another feature of the design is the plate-shaped insert piece 751 shown in FIG. 35 as having the shape of an elongated octagon with rounded corners. With respect to a central longitudinal axis and the central transverse axis, the insert piece has mirror symmetry. The two most distant corners are perpendicular to each other and the separation of the two parallel sides is less than the width of the elongated slots of either the cross leg or cross brace. The spacing between the other two sides is greater than the width of the elongated slot 724, but at most as large as the separation between the inner sides of the side walls of the cross leg 72. Ideally, the width of the side pair of edges is only slightly smaller than the separation of the side walls 722, so that the insert piece 751 fits snuggly within the cross leg. The insert piece 751 shown in FIG. 35 allows for simple installation on any site of the cross leg 72 because the insert piece 751 does not have to be inserted from a terminal end of the cross leg.

It should be understood that the programs, processes, methods and system described herein are not related or limited to any particular type components unless indicated otherwise. Various combinations of general purpose, specialized or equivalent components may be used with or perform operations in accordance with the teachings described herein. In view of the wide variety of embodiments to which the principles of the present invention can be applied, it should be understood that the illustrated embodiments are exemplary only, and should not be taken as limiting the scope of the present invention. For example, more, fewer or equivalent elements may be used in the embodiments.

I claim:

1. A compression fastener for securing a first joining piece to a second joining piece, the compression fastener comprising:
a first bracket and a second bracket, each bracket including
a first plate with a first flat surface secured to a second plate with a second flat surface,
the first flat surface
contacting the second flat surface, and
angled relative to the second flat surface in both a first dimension and a second dimension;
a first brace located between the first bracket and the second bracket, the first brace interconnecting with both the first plate and the second plate of both the first bracket and the second bracket.

2. The compression fastener of claim 1 further comprising
each of the first bracket and the second bracket further including the first flat surface having a first edge, the second flat surface having a second edge;
the first edge of the of the first bracket extending parallel to the first edge of the second bracket;
the second edge of the of the first bracket extending parallel to the second edge of the second bracket.

3. The compression fastener of claim 2 further comprising
each of the first bracket and the second bracket further including
the first edge
intersecting the second edge and
extending perpendicular to the second edge.

4. The compression fastener of claim 1 further comprising
the first brace includes a first flat sheet secured to, and perpendicular to, a second flat sheet;
a first knob and a second knob extending out from the first flat sheet;
a third knob and a fourth knob extending out from the second flat sheet;
the first knob and the third knob interconnecting with the first bracket; and
the second knob and the fourth knob interconnecting with the second bracket.

5. The compression fastener of claim 1 further comprising
a second brace located between the first bracket and the second bracket, each of the first brace and the second brace including:
a first flat sheet secured to a second flat sheet;
a first knob and a second knob extending out from the first flat sheet;
a third knob and a fourth knob extending out from the second flat sheet;
the first knob and the third knob interconnecting with the first bracket; and
the second knob and the fourth knob interconnecting with the second bracket.

6. The compression fastener of claim 5 wherein
the first flat sheet of the first brace is parallel to the first flat sheet of the second brace, and
the second flat sheet of the first brace is parallel to the second flat sheet of the second brace.

7. The compression fastener of claim 6 wherein
the first knob and the second knob of the first brace are separated by a first distance,
the third knob and the fourth knob of the first brace are separated by the first distance,
the first knob and the second knob of the second brace are separated by a second distance,
the third knob and the fourth knob of the second brace are separated by the second distance, and
the second distance is greater than the first distance.

8. The compression fastener of claim 1 further comprising
each of the first bracket and the second bracket further including
the first plate having a first inserted end adapted to be inserted into the first joining piece,
the second plate have a second inserted end adapted to be inserted into the second joining piece,
the first flat surface extending from the second flat surface to the first inserted end, and
the second flat surface extending from the first flat surface to the second inserted end.

9. The compression fastener of claim 8 wherein
all of the inserted ends include tapered corners.

10. An assembly with a compression fastener secured in a first joining piece, the assembly comprising:
the compression fastener including
a first bracket having
a first plate secured to a second plate, each plate having
a short edge,
a long edge extending parallel to the short edge,
a bendable surface extending from the short edge to the long edge,
an insertion edge connecting to both the sort edge and the long edge, and
a junction edge extending from the short edge to the long edge;
the junction edge of the first plate being the junction edge of the section plate;
the first joining piece including a cavity with a first slot, a second slot, and a first concave surface extending from the first slot to the second slot;
the short edge of the first plate of the first bracket compressed into the first slot,
the long edge of the first plate of the first bracket compressed in the second slot, and
the bendable surface of the first plate of the first bracket pressed against the first concave surface.

11. The assembly of claim 10 wherein
for each of the first bracket and the second bracket
the short edge of the first plate coplanar with the short edge of the second plate,
the long edge of the first plate coplanar with the long edge of the second plate, and
the short edge of the first plate non-coplanar with the long edge of the second plate.

12. The assembly of claim 10 further comprising
a second bracket having
a first plate secured to a second plate, each plate having
a short edge,
a long edge extending parallel to the short edge,
a bendable surface extending from the short edge to the long edge,
an insertion edge connecting to both the sort edge and the long edge, and
a junction edge extending from the short edge to the long edge;
the junction edge of the first plate being the junction edge of the section plate;
the cavity of the first joining piece having a third slot, a fourth slot, and a second concave surface extending from the third slot and the fourth slot;
the short edge of the first plate of the second bracket compressed into the third slot,
the long edge of the first plate of the second bracket compressed in the fourth slot; and
the bendable surface of the first plate of the second bracket pressed against the second concave surface.

13. The assembly of claim 12 wherein
the junction edge of the first plate of the first bracket is coplanar with the junction edge of the of the first plate of the second bracket.

14. The assembly of claim 12 wherein
the first slot is separated from the third slot by a first distance,
the second slot is separated from the fourth slot by a second distance, and
the second distance is substantially greater than the first distance.

15. The assembly of claim 12 further comprising
a first brace located between the first bracket and the second bracket, the first brace interconnecting with both the first plate and the second plate of both the first bracket and the second bracket.

16. The assembly of claim 15 further comprising
a second brace located between the first bracket and the second bracket, each of the first brace and the second brace including:
a first flat sheet secured to a second flat sheet;
a first knob and a second knob extending out from the first flat sheet;
a third knob and a fourth knob extending out from the second flat sheet;
the first knob and the third knob interconnecting with the first bracket; and
the second knob and the fourth knob interconnecting with the second bracket.

17. The assembly of claim 10 wherein
the short edge of the first plate of the first bracket intersects and is perpendicular to the short edge of the second plate of the first bracket.

18. The assembly of claim 10 wherein
the short edge and the long edge of the first plate of the first bracket are coplanar in a first geometric plane,
the short edge and the long edge of the second plate of the first bracket are coplanar in a second geometric plane, and
the junction edges of both the first plate and the second plate of the first bracket are located in both the first geometric plane and the second geometric plane.

19. The assembly of claim 10 further comprising
a second joining piece encircling the second plate of the first bracket,
the second joining piece cooperating with the first joining piece to fully enclose the compression fastener.

20. The assembly of claim 10 further comprising
a hinged coupling unit having a first part rotatable relative to a second part,
the first part having a first portion secured to the first joining piece at the second slot; and
the second part having a second portion secured to the first joining piece at the first slot, and a coupling concave surface extending from the second portion to the first portion, the coupling concave surface being substantially defined by the first concave surface of the first joining piece.

21. The assembly of claim 20 further comprising
the cavity of the first joining piece having a third slot, a fourth slot, and a second concave surface extending from the third slot and the fourth slot;
the first part of the hinged coupling having a conical recess, the second slot secured within the conical recess; and
the second part of the hinged coupling having a nose clamp located between the first slot and the third slot of the first joining piece.
